(19) United States
(12) Patent Application Publication
(10) Pub. No.: US 2020/0333657 A1
(43) Pub. Date: Oct. 22, 2020

(54) DISPLAY PANEL

(71) Applicant: SHARP KABUSHIKI KAISHA, Sakai City, Osaka (JP)

(72) Inventors: RYOSUKE TAKAHASHI, Sakai City, Osaka (JP); SHIGEKI TANAKA, Sakai City, Osaka (JP); YUKIO KUROZUMI, Sakai City, Osaka (JP); RYOH UEDA, Sakai City, Osaka (JP)

(21) Appl. No.: 16/494,888

(22) PCT Filed: Mar. 13, 2018
(86) PCT No.: PCT/JP2018/009747

§ 371 Date: Jul. 1, 2020

(30) Foreign Application Priority Data
Mar. 21, 2017 (JP) 2017-054182

(51) Int. Cl. G02F 1/1333; G02F 1/1339; G02F 1/1337

(52) U.S. Cl. CPC G02F 1/133345; G02F 1/1337; G02F 1/1339

(57) ABSTRACT

A display panel includes paired substrates including plate faces each divided into an active area and a non-active area and facing each other across an interior space, a sealing portion interposed between the paired substrates and arranged in the non-active area in such a manner as to surround the interior space for sealing the interior space, an alignment film disposed on at least the display area on one of the paired substrates, an insulating film disposed on the one of the paired substrates farther from the interior space than the alignment film and arranged across the active area and the non-active area, and a recess portion disposed in the non-active area on the insulating film in such a manner as to overlap the sealing portion and including at least a first recess and a second recess configured to extend in such a manner as to surround the first recess.

### TECHNICAL FIELD

The present invention relates to a display panel.

### BACKGROUND ART

Examples of currently-known liquid crystal panels as a main part constituting a liquid crystal display device include one described in Patent Literature 1 as below. The liquid crystal panel includes a sealing portion on a TFT substrate. The sealing portion includes holes on an organic passivation film at given pitches in plan view. The shortest distance between the adjacent holes in a planar shape ranges from 4 to 12 μm. With such a configuration, even if an alignment film material is formed to an edge of the substrate, formation of the alignment film to the edge of the substrate is performable since no alignment film covers the holes of the sealing portion.

### RELATED ART DOCUMENT

### [Patent Document]

### Patent Document 1

Japanese Application Patent Publication No. 2016-109807A

### [Problem to be Solved by the Invention]

When the liquid crystal panel including the configuration described in the above Patent Literature 1 is further narrowed, an installation number of holes is reduced and additionally a width by which the sealing portion is formed becomes small. This causes reduction in adhesive strength of the sealing portion, leading to an increased possibility of removal of the sealing portion from both substrates.

### DISCLOSURE OF THE PRESENT INVENTION

The technology described herein was made in view of the above circumstances. An object is to suppress or prevent removal of a sealing portion.

### [Means for Solving the Problem]

An embodiment of the present invention includes a display panel including paired substrates, a sealing portion, an alignment film, an insulating film, and a recess portion. The paired substrates include plate faces that are each divided into an active area where an image is displayed and a non-active area out of the active area and are arranged in such a manner as to face each other across an interior space. The sealing portion is interposed between the paired substrates and is arranged in the non-active area in such a manner as to surround the interior space for sealing the interior space. The alignment film is disposed on at least the display area on one of the paired substrates. The insulating film is disposed on the one of the paired substrates farther from the interior space than the alignment film and is arranged across the active area and the non-active area. The recess portion is disposed in the non-active area on the insulating film in such a manner as to overlap the sealing portion. The recess portion includes at least a first recess and a second recess configured to extend in such a manner as to surround the first recess.

With such a configuration, the interior space between the paired substrates is surrounded and thus sealed by the sealing portion disposed between the paired substrates in the non-active area. When a material of the alignment film supplied to the active area spreads up to the non-active area while the alignment film to be disposed in at least the active area is formed, the alignment film overlaps the sealing portion. In such a condition, the adhesive strength of the sealing portion with respect to the one of the substrates may be reduced. Especially, the adhesive strength of the sealing portion is likely to be reduced significantly as a narrower frame is developed. Here, the recess portion is disposed at a position of the insulating film in the one of the substrates farther from the interior space than the alignment film, and at the position, the insulating film overlays the sealing portion in the non-active area. The recess portion includes at least the first recess and the second recess configured to extend in such a manner as to surround the first recess. Consequently, the material of the alignment film having spread up to the non-active area is unlikely to flow toward the first recess beyond the second recess, and thus the material of the alignment film is unlikely to enter the first recess. Such a situation occurs. Accordingly, the alignment film is unlikely to overlap at least a region of the sealing portion where the first recess is covered. Therefore, the adhesive strength of the sealing portion with respect to the one of the substrates can be kept sufficiently high even if a narrower frame is developed, leading to difficulty in removal of the sealing portion.

The following configuration is preferred for the embodiment of the present invention.
(1) The one of the paired substrates includes a metal film and a circuit portion. The metal film is disposed farther from the interior space than the insulating film. The circuit portion is disposed at least in the non-active area, and is formed by the metal film. The insulating film includes a circuit covering portion configured to cover the circuit portion. The circuit covering portion is partially recessed to form the recess portion. With such a configuration, the insulating film includes the circuit covering portion configured to cover the circuit portion formed by the metal film. This causes difficulty in building up corrosion in the circuit portion. The recess portion is formed by recessing the circuit covering portion partially. This causes difficulty in loss of an anticorrosive function of the circuit portion by the insulating film.

(2) The one of the paired substrates has a rectangular planar shape, and includes an outer circumference portion with corner portions and side portions adjacent to the corner portions. The corner portions each include a circuit non-arrangement area where the circuit portion is not arranged. The side portions each include a circuit arrangement area where the circuit portion is arranged. The insulating film includes a main portion that is disposed inwardly from an outer edge of one of the paired substrates, and is configured not to be arranged in at least the circuit non-arrangement area and configured to contain the circuit covering portion. In the circuit non-arrangement area, tubular portions are provided in such a manner as to be spaced apart from the main portion. The tubular portions are formed by the insulating film and each include an opening at the center. In doing so, the corner portions of the outer circumference in one of the paired substrates each include the circuit non-arrangement area where the circuit portion is not arranged. Accordingly, even if the main portion of the insulating film is not arranged in the circuit non-arrangement area, this is unlikely to influence corrosion of the circuit portion. The circuit non-arrangement area where the main portion of the insulating film is not arranged achieves an enhanced adhesive strength of the sealing portion at the corner portions. In addition, the tubular portions formed by the insulating film and each including the opening at the center thereof are disposed in the circuit non-arrangement area. The tubular portions are configured to be spaced apart from the main portion of the insulating film. Consequently, even if the material of the alignment film reaches the tubular portions beyond the main portion of the insulating film while the alignment film is formed, the material is unlikely to enter into the opening beyond the tubular portion. Such a situation occurs. Therefore, the adhesive strength of the sealing portion with respect to one of the substrates can be kept sufficiently high, leading to difficulty in removal of the sealing portion.

(3) The insulating film includes at least a recess arrangement insulating film including the recess portion selectively and a recess non-arrangement insulating film. With such a configuration, the circuit covering portion of the recess non-arrangement insulating film without any recess portion overlaps the circuit covering portion of the recess arrangement insulating film with the recess portion. This causes more difficulty in building up corrosion in the circuit portion.

(4) The recess arrangement insulating film has a film thickness larger than that of the recess non-arrangement insulating film. In doing so, the film thickness of the recess arrangement insulating film including the recess portion selectively is relatively large. This ensures a sufficient depth of the recess portion. Consequently, the recess portion enables suitable regulation of flow of the alignment film.

(5) The recess non-arrangement insulating film has a film thickness larger than that of the recess arrangement insulating film. In doing so, the film thickness of the recess non-arrangement insulating film where no recess portion is arranged is relatively large. This makes it more difficult to cause the circuit covering portion of the recess non-arrangement insulating film to corrode the circuit portion.

(6) The insulating film includes at least a first insulating film whose film thickness is relatively large, and a second insulating film whose film thickness is relatively small. The recess portion includes at least the second recess selectively in the first insulating film. In doing so, the second recess is deeper than a case where the second recess is selectively disposed in the second insulating film. Consequently, the second recess enables suitable regulation of flow of the alignment film. This makes it more difficult to cause the material of the alignment film to reach the first recess.

(7) The first recess of the recess portion is a through hole in the first insulating film and the second insulating film. In doing so, the sealing portion enables to contact one of the paired substrates directly through the first recess as the through hole in the first insulating film and the second insulating film. The second recess regulates flow of the material of the alignment film, whereby the first recess positively functions to ensure the adhesive strength of the sealing portion. Accordingly, the adhesive strength of the sealing portion to one of the paired substrates becomes higher.

(8) The sealing portion is provided in such a manner that its outer edge is withdrawn inwardly from an outer edge of one of the paired substrates. The insulating film includes a main portion withdrawn inwardly from the outer edge of the sealing portion by a gap smaller than an external diameter of the second recess forming the recess portion. The recess portion is provided in the main portion. Firstly, the outer edge of the sealing portion is provided so as to be withdrawn inwardly from the outer edge of one of the paired substrates. Accordingly, when the display panel of this type is produced by dividing a preform panel composed by coupling the display panels, for example, the sealing portion is disposed out of a point where the preform panel is divided. This achieves easy division. Whereas, when the outer edge of the sealing portion is provided so as to be withdrawn inwardly from the outer edge of one of the paired substrates, a gap between the outer edge of the sealing portion and the main portion of the insulating film withdrawn inwardly from the outer edge of the sealing portion is occasionally smaller than the external diameter of the second recess. In such a condition, it becomes difficult to set a structure, such as the recess portion, for flow of the alignment film between the main portion and the outer edge of the sealing portion is regulated. Regarding this, providing the recess portion in the main portion allows suitable flow of the alignment film in the main portion, which makes it difficult to cause removal of the sealing portion.

(9) The second recess of the recess portion has an endless annular shape. In doing so, flow of the material of the alignment film toward the first recess is regulatable with higher accuracy than a case where the second recess has an ended annular shape. Consequently, the material of the alignment film is more unlikely to enter into the first recess.

(10) Recess portions are spaced apart by gaps along a circumferential direction of one of the paired substrates, and at least the second recesses each have an annular ring contour. Even if the second recesses forming the recess portions extend along the circumferential direction of one of the paired substrates, the second recesses may cause the material of the alignment film flowing during formation of the film to return toward the active area, resulting in an uneven film thickness of the alignment film. In contrast to this, the recess portions arranged along the circumferential direction of one of the paired substrates are spaced apart by gaps, and additionally, the second recesses each have an annular ring contour. In the non-active area, with assistance of the gaps and the contour of the second recesses, it is possible to let the flowing material of the alignment film escape to a direction away from the active area. This makes it easy to obtain the even film thickness of the alignment film in the non-active area.

(11) The recess portion each includes a third recess configured to extend in such a manner as to surround the second recess. With such a configuration, the second recess configured to extend in such a manner as to surround the first recess is also surrounded by the third recess. Accordingly, the material of the alignment film is necessarily beyond the third and second recesses to reach the first recess when the film is formed. This makes it more difficult for a region of the sealing portion that covers at least the first recess to overlap the alignment film. Then, the adhesive strength of the sealing portion to one of the paired substrates can kept higher with high reliability.

(12) First recesses of the recess portions are spaced apart by gaps in a region surrounded by the second recesses. With such a configuration, even when the material of the alignment film is beyond the second recess and reaches the region surrounded by the second recess, the first recesses are arranged in the region. Accordingly, a probability that the first recesses without the material of the alignment film becomes higher than a case where only one first recess is provided. This makes it more difficult for a region of the sealing portion that covers at least the first recess to overlap the alignment film. Then, the adhesive strength of the sealing portion to one of the paired substrates can be kept higher with high reliability.

### [Advantageous Effects of Invention]

The present invention enables suppression or prevention of removal of the sealing portion.

### BRIEF DESCRIPTION OF THE DRAWINGS

FIG. 1 is a schematic plan view of connection between a liquid crystal panel and a flexible board according to a first embodiment of the present invention.

FIG. 2 is a schematic sectional view illustrating an overall sectional configuration of the liquid crystal panel.

FIG. 3 is a schematic plan view of wiring at an active area of an array substrate that forms the liquid crystal panel.

FIG. 4 is a sectional view along the A-A line of FIG. 3.

FIG. 5 is a plan view illustrating a planar configuration of a corner portion of an array substrate and side portions adjacent thereto.

FIG. 6 is an enlarged plan view around recess portions.

FIG. 7 is a further enlarged plan view around the recess portions.

FIG. 8 is a perspective view of the recess portions and other components.

FIG. 9 is a sectional view along a B-B line of FIG. 6.

FIG. 10 is a sectional view along a C-C line of FIG. 6.

FIG. 11 is a plan view of recess portions according to a second embodiment.

FIG. 12 is a plan view of recess portions according to a third embodiment.

FIG. 13 is a plan view of recess portions according to a fourth embodiment.

FIG. 14 is a plan view of recess portions according to a fifth embodiment.

FIG. 15 is a sectional view along a B-B line of FIG. 14.

FIG. 16 is a plan view of recess portions according to a sixth embodiment.

FIG. 17 is a sectional view along a B-B line of FIG. 16.

FIG. 18 is a plan view of recess portions according to a seventh embodiment.

FIG. 19 is a sectional view along a B-B line of FIG. 18.

FIG. 20 is a plan view of recess portions according to another embodiment (1) of the present invention.

FIG. 21 is a plan view of recess portions according to another embodiment (2) of the present invention.

FIG. 22 is a plan view of recess portions according to another embodiment (3) of the present invention.

FIG. 23 is a plan view of recess portions according to another embodiment (4) of the present invention.

### MODES FOR CARRYING OUT THE INVENTION

### First Embodiment

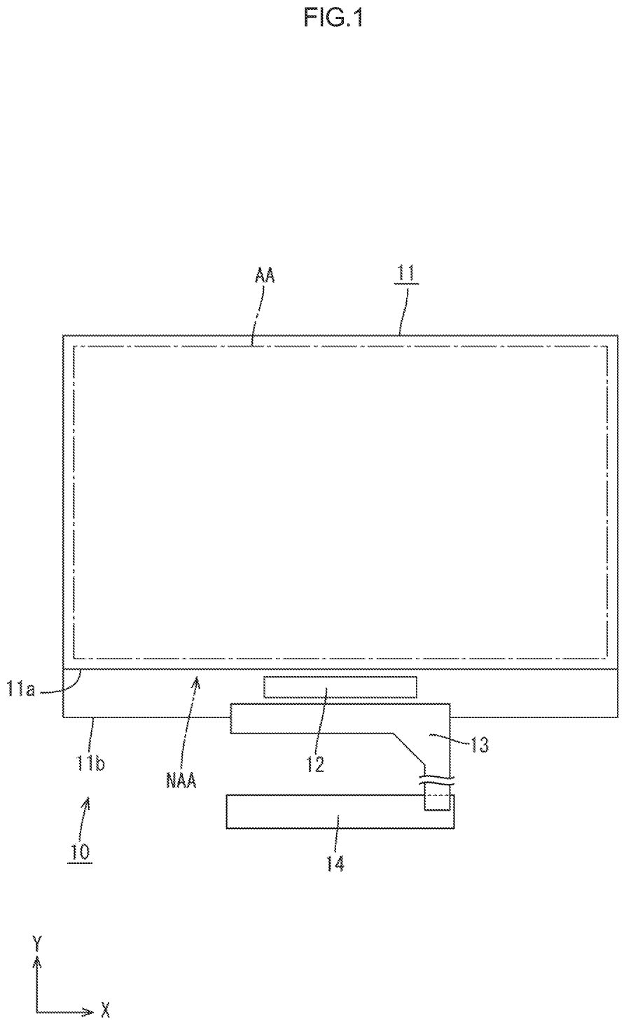

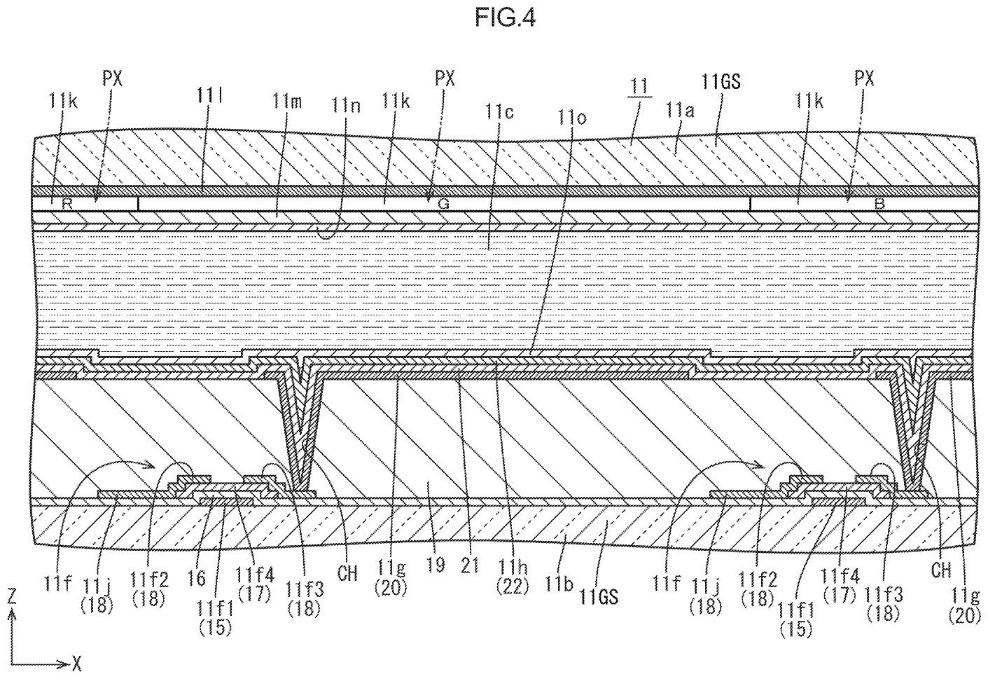

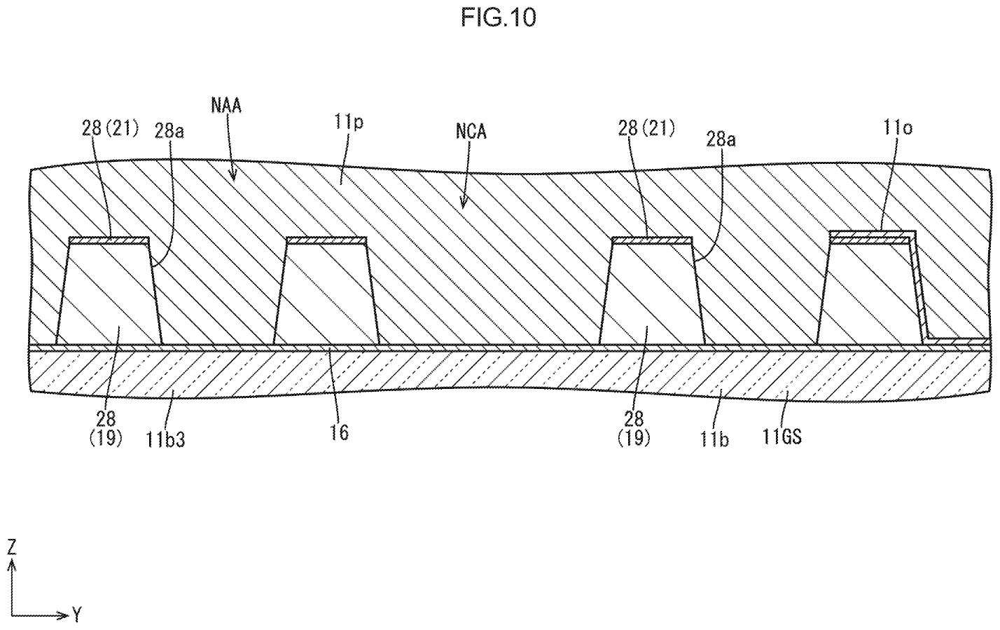

The following describes a first embodiment of the present invention with FIGS. 1 to 10. The present embodiment exemplarily describes a liquid crystal panel (display panel) 11 provided in a liquid crystal display device 10. Note that each of drawings partially indicates an X-axis, a Y-axis, and a Z-axis, each of which corresponds to the direction where the drawing illustrates. Moreover, upward and downward directions illustrated in FIGS. 4, 9, and 10 correspond to front and rear sides, respectively.

As illustrated in FIG. 1, the liquid crystal display device 10 includes at least a liquid crystal panel 11 capable of displaying an image, a driver (panel driving portion) 12 configured to drive the liquid crystal panel 11, a control circuit board (external signal supplying source) 13 configured to supply various external input signals to the driver 12, a flexible board (external connecting part) 14 configured to connect the liquid crystal panel 11 and the external control circuit board 13 electrically, and a back light device (not shown) as an external light source that is disposed at a rear side with respect to the liquid crystal panel 11 and is configured to apply light for display to the liquid crystal panel 11. The liquid crystal panel 11 of the liquid crystal display device 10 has a screen size of around ten or more inches, for example. Accordingly, the liquid crystal display device 10 is suitably used for a notebook personal computer. It should be noted that, in addition to the screen size and the application mentioned above, another specific screen size of the liquid crystal panel 11 and another specific application of the liquid crystal display device 10 are variable appropriately.

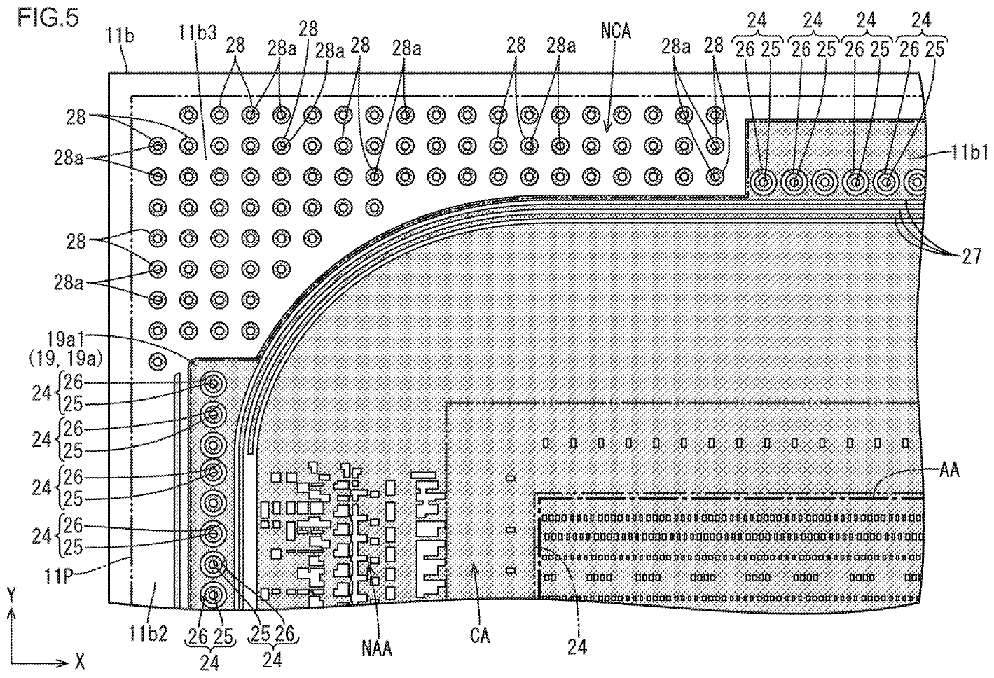

As illustrated in FIG. 1, the liquid crystal panel 11 is substantially oblong (rectangular) in its entirety. The liquid crystal panel 11 includes a plate face divided into an active area AA capable of displaying an image and is arranged at a center region, and a non-active area NAA that is arranged along an outer circumference of the active area AA in such a manner as to surround the active area AA in a box shape (frame shape) in plan view. The liquid crystal panel 11 includes a long side whose direction corresponds to an X-axis direction in each drawing, a short side whose direction corresponds to a Y-axis direction in each drawing, and a plate thickness whose direction corresponds to a Z-axis direction. It should be noted that FIGS. 1 and 5 each illustrate a contour of the active area AA by inner alternate long and short dashed lines, and the non-active area NAA is an area external of the inner alternate long and short dashed lines.

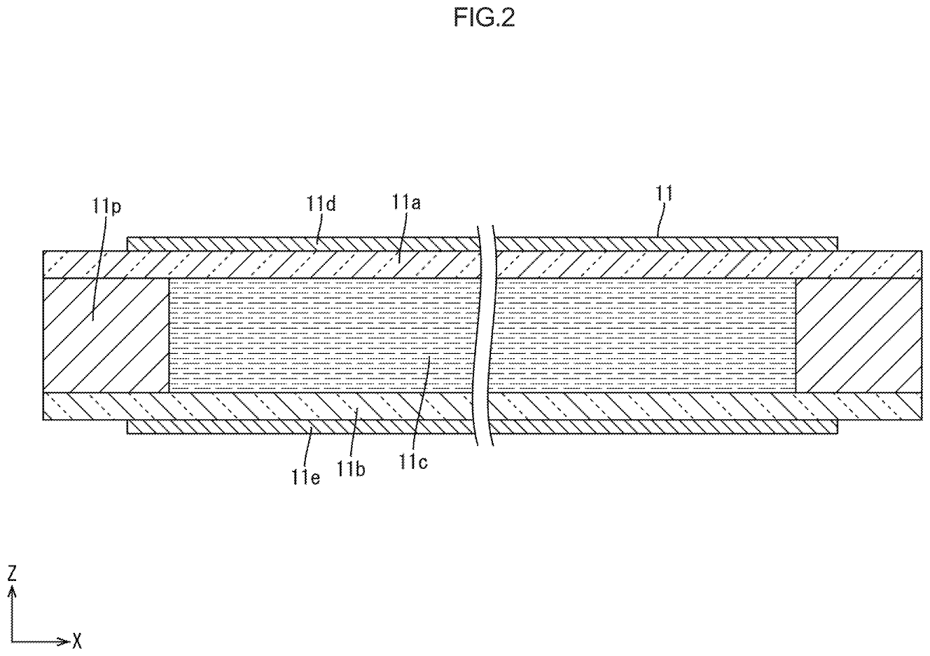

As illustrated in FIG. 2, the liquid crystal panel 11 includes at least paired substrates 11a, 11b, a liquid crystal layer 11c, and a sealing portion 11p. The liquid crystal layer 11c is disposed in an interior space 11IS between the opposite plate faces of the paired substrates 11a, 11b, and contains liquid crystal molecules as a material whose optical property is variable depending on electric field application. The sealing portion 11p is disposed between the paired substrates 11a, 11b in such a manner as to surround the interior space 11IS and the liquid crystal layer 11c, thereby sealing the interior space 11IS and the liquid crystal layer 11c with a maintained cell gap by a thickness of the liquid crystal layer 11c. A front side (surface side) of the paired substrates 11a, 11b is referred to as a CF substrate (the other of the substrates, opposite substrate) 11a, whereas a rear side (backside) thereof is referred to as an array substrate (one of the substrates, active matrix substrate) 11b. The CF substrate 11a and the array substrate 11b each include various films laminated on an internal face of a glass substrate 11GS made of glass. The sealing portion 11p is arranged in a non-active area NAA of the liquid crystal panel 11. The sealing portion 11p has substantially an oblong box shape so as to conform to a shape of the non-displayed area NAA in plan view (seen from a normal line with respect to the plate faces of the paired substrates 11a, 11b) (see FIG. 1). Moreover, polarizers 11d, 11e adhere to outer faces of the paired substrates 11a, 11b, respectively.

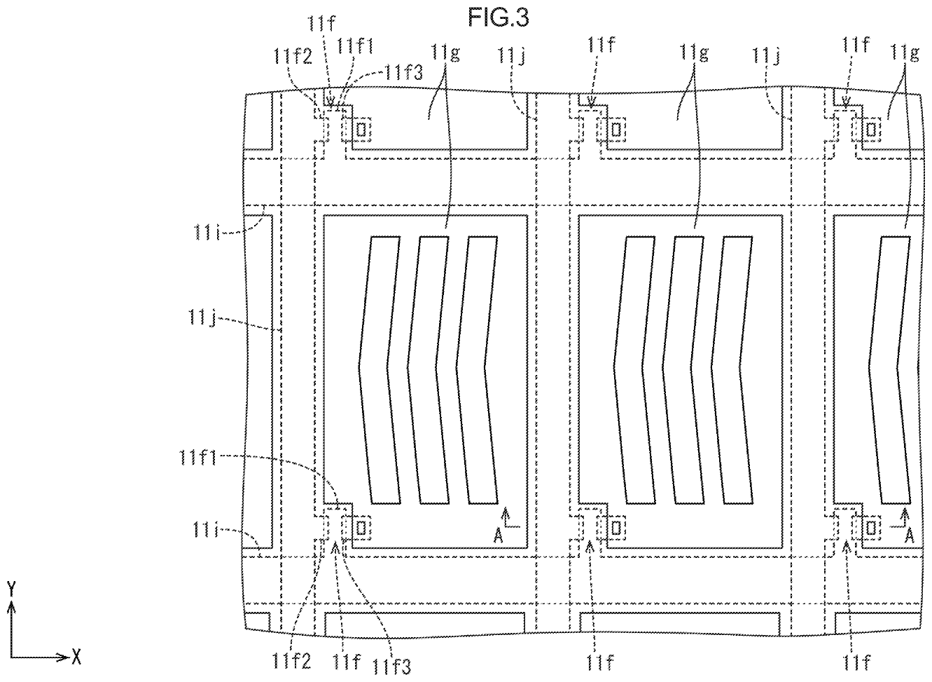

As illustrated in FIGS. 3 and 4, multiple thin film transistors (TFTs) 11f as switching elements and multiple pixel electrodes 11g are arranged in a matrix array (in a row and column manner) in the active area AA on an inner face side of the array substrate 11b (adjacent to the liquid crystal layer 11c, opposite to the CF substrate 11a). In addition, gate lines (scanning lines) 11i and source lines (data lines, signal lines) 11j are arranged in a grid shape as to surround the TFTs 11f and the pixel electrodes 11g. The gate lines 11i and the source lines 11j are connected to gate electrodes 11f1 and source electrodes 11f2 of the TFTs 11f, respectively. The pixel electrodes 11g are connected to drain electrodes 11f3 of the TFTs 11f. Moreover, the TFTs 11f are driven in accordance with various signals supplied to the gate lines 11i and the source lines 11j. Supply of electric potential to the pixel electrodes 11g is controlled in association with the drive. The pixel electrodes 11g are arranged in rectangular regions surrounded by the gate lines 11i and the source lines 11j. The active area AA of the array substrate 11b includes the inner face side where a common electrode 11h is formed in a flat pattern on an upper layer above the pixel electrodes 11g so as to overlap with the pixel electrodes 11g. When a potential difference occurs between the pixel electrodes 11g and the common electrode 11h overlapping each other, a fringing field (oblique electric field) is applied to the liquid crystal layer 11c. The fringing field includes a normal line component with respect to the plate face of the array substrate 11b in addition to a plate component of the array substrate 11b.

That is, the liquid crystal panel 11 according to this embodiment operates in a mode referred to as a fringe field switching (FFS) mode. In each of the drawings in the present embodiment, an extending direction of the gate lines 11i corresponds to an X-axis direction, and an extending direction of the source lines 11j corresponds to a Y-axis direction.

In contrast to this, as illustrated in FIGS. 3 and 4, the active area AA of the CF substrate 11a includes an inner face side where multiple color filters 11k are provided in a matrix array in such a manner as to face the pixel electrodes 11g adjacent to the array substrate 11b. The color filters 11k are formed by three colored films of R (red), G (green), and B (blue) arranged repeatedly in a given order. A light-shielding film (black matrix) 111 in a grid shape is provided between adjacent color filters 11k for preventing color mixture. The light-shielding film 111 overlaps the gate lines 11i and the source lines 11j described above in plan view. An overcoat film 11m is provided on surfaces of the color filters 11k and the light-shielding film 111. A photo spacer, not shown, is provided on a surface of the overcoat film 11m. Here, in the liquid crystal panel 11, a group of the colored film with three colors of R, G, B in the color filter 11k and three pixel electrodes 11g facing thereto forms one display pixel as a unit for display. The display pixels each include a red pixel with the color filter 11k of R, a green pixel with the color filter 11k of G, and a blue pixel with the color filter 11k of B. The display pixels with these colors are repeatedly arranged in a row direction (X-axis direction) on the plate face of the liquid crystal panel 11. This forms multiple display pixel groups that are arranged in a column direction (Y-axis direction).

Both the substrates 11a, 11b include innermost faces (adjacent to the liquid crystal layer 11c) contacting the liquid crystal layer 11c. On the innermost faces, alignment films 11n, 11o are formed, respectively, for orientation of the liquid crystal molecules contained in the liquid crystal layer 11c. Both the alignment films 11n, 11o are made of polyimide, for example, and are formed in a flat shape substantially entirely of at least the active area AA of the substrates 11a, 11b, respectively, and additionally over an inner circumference side of the non-active area NAA adjacent to the active area AA. Light with a specific wavelength (e.g., ultraviolet rays) is applied to the alignment films 11n, 11o to allow orientation of the liquid crystal molecules along a direction where the light is applied. Such alignment film is referred to as a light alignment film.

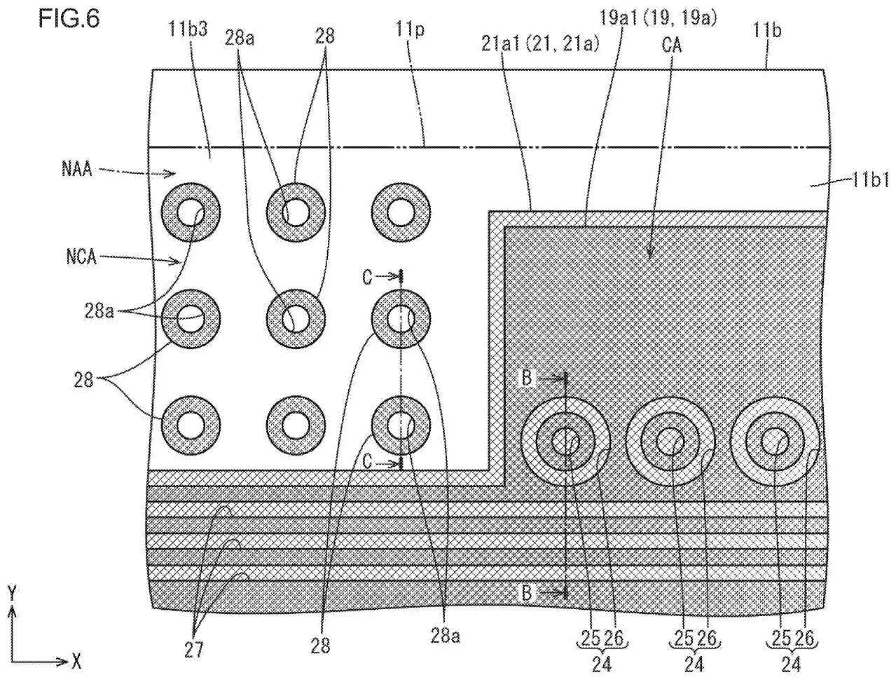

Then, description is made of various types of films laminated on the inner side face of the array substrate 11b. As illustrated in FIG. 6, the array substrate 11b includes, in this order from a lower layer side (glass substrate 11GS side, side farther from the interior space 11IS), a first metal film (metal film) 15, a gate insulating film 16, a semiconductor film 17, a second metal film (metal film) 18, a planate film (insulating film, first insulating film, recess arrangement insulating film) 19, a first transparent electrode film 20, an interlayer insulating film (insulating film, second insulating film, recess non-arrangement insulating film) 21, a second transparent electrode film 22, and an alignment film 11o in a laminated manner.

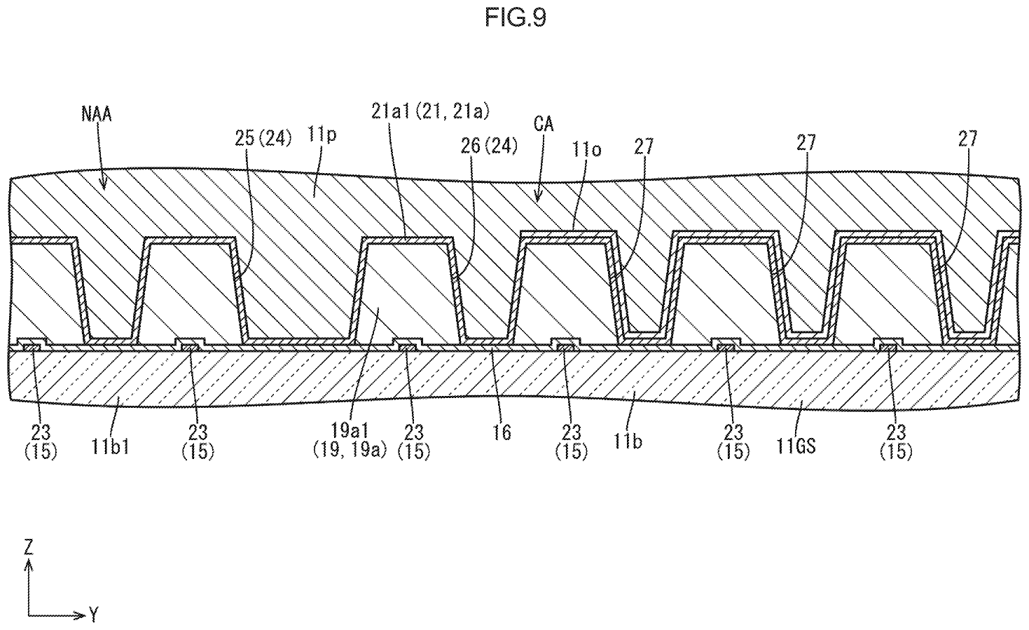

The first metal film 15 and the second metal film 18 are each a single film made from a one-type metal material or a laminated film made from different types of metal materials selected from copper, titanium, aluminum, for example, or an alloy, thereby having conductivity and light-blocking property. Among them, as illustrated in FIGS. 4 and 9, the first metal film 15 forms the gate lines 11i, and the gate electrodes 11f1 of the TFTs 11f, as well as a circuit portion 23 mentioned later. The second metal film 18 forms the source lines 11j, and the source electrodes 11f2 and the drain electrodes 11f3 of the TFTs 11f as well as the circuit portion 23 mentioned later. The gate insulating film 16 and the interlayer insulating film 21 are each made from an inorganic material such as silicon nitride (SiNₓ) and silicon oxide (SiO₂). The gate insulating film 16 and the interlayer insulating film 21 each have a film thickness smaller than the planate film 19 mentioned later. The film thickness preferably falls within a range of around 0.2 to 0.3 μm. However, such a range is not necessarily limitative. The gate insulating film 16 keeps an insulated state between the first metal film 15 and the semiconductor film 17 and the second metal film 18. The interlayer insulating film 21 keeps an insulated state between the first transparent electrode film 20 and a second transparent electrode film 22. The semiconductor film 17 is formed by a thin film with a material of an oxide semiconductor having higher electron mobility than an amorphous silicon thin film, for example. The semiconductor film 17 form channels 11f4 connected to the source electrodes 11f2 and the drain electrodes 11f3 in the TFTs 11f. Examples of the oxide semiconductor forming the semiconductor film 17 include an In—Ga—Zn—O semiconductor device (e.g., oxidation indium gallium zinc) . The TFT 11f including the channel 11f4 formed by the semiconductor film 17 with the oxide semiconductor is referred to as an “oxide semiconductor TFT (IGZO-TFT)”. Accordingly, this allows reduction in size and is advantageous for high definition and high aperture ratio. Moreover, this achieves a high off-characteristic to reduce leak current, which is also advantageous for lowered power consumption. Moreover, in comparison with the amorphous silicon thin film, for example, the oxide semiconductor forming the semiconductor film 17 has the electron mobility around 20 to 50 times higher, and leak current flowing therethrough becomes extremely small to around one hundredth. The planate film 19 is made from an organic material such as acrylic resin (e.g., polymethyl methacrylate (PMMA)). The planate film 19 functions to planarize steps generated on a lower layer side than itself, and keeps an insulated state between the second metal film 18 and the first transparent electrode film 20. The planate film 19 has a film thickness larger than the other insulating films 16, 21 made from an inorganic material. The film thickness is preferably around 2 μm, for example, but this is not necessarily limitative. The gate insulating film 16, the planate film 19, and the interlayer insulating film 21 are each arranged across the active area AA and the non-active area NAA in a substantially flat shape. The first transparent electrode film 20 and the second transparent electrode film 22 are each made from a transparent electrode material (e.g., an indium tin oxide (ITO)). Among them, the first transparent electrode film 20 forms the pixel electrodes 11g, whereas the second transparent electrode film 22 forms the common electrodes 11h. The planate film 19 includes contact holes CHs formed therein in an opened manner. The contact holes CHs are each configured to connect the pixel electrode 11g formed by the first transparent electrode film 20 to the drain electrode 11f3 formed by the second metal film 18. The alignment film 11o is laminated on the second transparent electrode film 22 and the upper layer side of the interlayer insulating film 21. Accordingly, the alignment film 11o directly borders the liquid crystal layer 11c.

The following describes a configuration in the non-active area NAA of the array substrate 11b in detail. As illustrated in FIG. 5, the array substrate 11b includes the circuit portion 23 in the inner circumference side of the non-active area NAA adjacent to the active area AA. The circuit portion 23 has a substantially box shape to surround the active area AA, and is covered with a part of the sealing portion 11p in plan view. Here, FIG. 5 illustrates the circuit portion 23 by fine chain double-dashed lines and the sealing portion 11p by bold chain double-dashed lines. More specifically, an inner edge of the circuit portion 23 is positioned closer to the active area AA than to an inner edge of the sealing portion 11p, and thus adjacent to the active area AA as in FIG. 5. As already described above, the array substrate 11b is oblong in plan view, and includes paired long-side portions 11b1, paired short-side portions 11b2, and four corner portions 11b3 disposed at four corners, respectively, and formed by adjacent side portions 11b1, 11b2 on its outer circumference region in an oblong shape. The circuit portions 23 are disposed on most of the side portions 11b1, 11b2 of the outer circumference region, whereas the circuit portions 23 are only partially disposed on the inner circumference region of the corner portions 11b3. Consequently, the side portions 11b1, 11b2 correspond to a circuit arrangement area CA a great part of which the circuit portions 23 are arranged. In contrast to this, only apart of the corner portions 11b3 on its inner circumference region correspond to as the circuit arrangement area CA, whereas a great part thereof correspond to as a circuit non-arrangement area CNA where no circuit portion 23 is arranged. The circuit portion 23 includes a display control circuit configured to perform control to supply output signals from the driver 12 to the TFTs 11f, a repair circuit configured to repair various lines contained in the display control circuit, and an inspection circuit configured to inspect the display control circuit. Among them, the display control circuit includes a scanning circuit (gate driver circuit), and a switch circuit (RGB switch circuit). The scanning circuit supplies scanning signals contained in the output signals from the driver 12 to the gate lines 11i at given timing to scan the gate lines 11i sequentially. The switch circuit splits image signals contained in the output signals from the driver 12 to the source lines 11j. The circuit portion 23 is formed by the first metal film 15, the semiconductor film 17, and the second metal film 18. The circuit portions 23 are formed on the array substrate 11b monolithically.

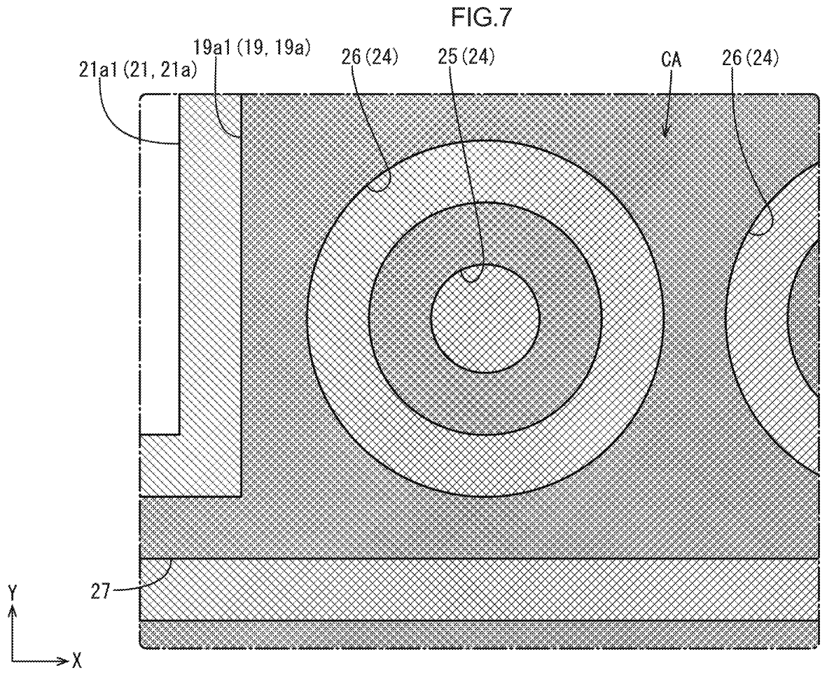

Subsequently, the following describes a region where the planate film 19 and the interlayer insulating film 21 are formed in the non-active area NAA of the array substrate 11b. As illustrated in FIG. 5, the planate film 19 and the interlayer insulating film 21 are formed almost entire the active area AA, and additionally in the inner circumference region of the non-active area NAA. A region where the planate film 19 and the interlayer insulating film 21 are arranged across the active area AA and the non-active area NAA is considered as main portions 19a, 21a, respectively. The main portions 19a, 21a of the planate film 19 and the interlayer insulating film 21, respectively, are formed in an area larger by one order than the circuit portion 23 in the non-active area NAA. In other words, the main portions 19a, 21a of the planate film 19 and the interlayer insulating film 21, respectively, are formed in the inner circumference region of the non-active area NAA so as to cover an almost entire part of the circuit portion 23 in the non-active area NAA. Regions of the main portions 19a, 21a covering the circuit portions 23 correspond to as circuit covering portions 19a1, 21a1, respectively. The region except for the circuit covering portions 19a1, 21a1 is arranged in the active area AA. The circuit portions 23 are covered with the circuit covering portions 19a1, 21a1. This causes difficulty in building up corrosion in a region of the circuit portions 23 formed by the first metal film 15 and the second metal film 18. A great part of the region of the non-active area NAA in the array substrate 11b on the outer circumference region with respect to the main portions 19a, 21a except for tubular portions 28 mentioned later is an insulating film non-arrangement area where the planate film 19 and the interlayer insulating film 21 are not arranged. As illustrated in FIG. 6, the main portion (second insulating film main portion) 21a of the interlayer insulating film 21 is formed in an area larger by one order than the main portion (first insulating film main portion) 19a of the planate film 19. As described above, a great part of the corner portions 11b3 of the array substrate 11b is the circuit non-arrangement area CNA. Accordingly, if the main portions 19a, 21a of the planate film 19 and the interlayer insulating film 21 are not arranged in the corner portion 11b3, the corner portion 11b3 is unlikely to influence corrosion of the circuit portion 23. The main portions 19a, 21a of the planate film 19 and the interlayer insulating film 21 are not arranged in the circuit non-arrangement area CNA, leading to an enhanced adhesive strength of the sealing portion 11p at the corner portion 11b3. In addition, the region described above where the gate insulating film 16 is formed is substantially same as that where the planate film 19 and the interlayer insulating film 21 are formed, which detailed description is to be omitted. Here in FIG. 5, the planate film 19 is shaded and the interlayer insulating film 21 is omitted. In contrast to this, in FIGS. 6 and 7, the planate film 19 and the interlayer insulating film 21 are hatched in different manners (specifically, the planate film 19 is hatched in a dotted manner and the interlayer insulating film 21 is hatched in a netted manner), and a region where the planate film 19 and the interlayer insulating film 21 cover is hatched mutually in a superimposed manner.

Now, as illustrated in FIGS. 5 and 9, the non-active area NAA of the planate film 19 among the insulating films 16, 19, 21 in the array substrate 11b of this embodiment includes recess portions 24 covered with the sealing portion 11p. The recess portions 24 are provided such that the main portion 19a of the planate film 19 is partially recessed. Specifically, the recess portions 24 are disposed on the circuit covering portions 19a1 of the main portion 19a. That is, the recess portions 24 overlaps the circuit portions 23 in plan view, and partially recess the circuit covering portion 19a1. In other words, the recess portions 24 are selectively disposed on the long-side portions 11b1 and the short-side portions 11b2 of the array substrate 11b on the outer circumference region, and thus are not disposed on the corner portions 11b3. The plural recess portions 24 are spaced apart in the long-side portion 11b1 and the short-side portion 11b2 of the array substrate 11b in a line in a circumferential direction. The plural recess portions 24 disposed on the long-side portion 11b1 are arranged intermittently in the X-axis direction in which the long-side portion 11b1 extends, whereas the plural recess portions disposed on the short-side portion 11b2 are arranged intermittently in the Y-axis direction in which the short-side portion 11b2 extends. Moreover, the recess portions 24 are formed by recessing the circuit covering portion 19a1 in the planate film 19 partially, and are spaced apart by gaps in a line. This causes difficulty in loss of an anticorrosive function of the circuit portions 23 by the planate film 19. Here, FIG. 9 illustrates a part of the circuit portions 23 formed by the first metal film 15.

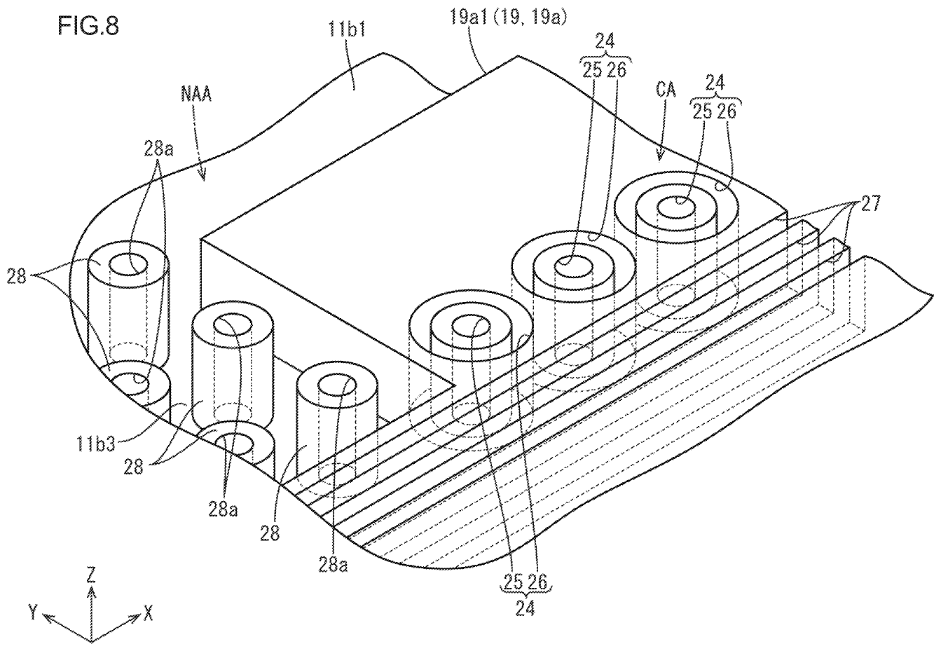

As illustrated in FIGS. 6 and 8, the recess portions 24 each include a first recess 25 and a second recess 26 configured to extend in such a manner as to surround the first recess 25. Specifically, the first recess 25 forming the recess portion 24 has a circular planar shape. In contrast to this, the second recess 26 forming the recess portion 24 has an endless annular ring (endless ring, annular ring, toroidal) shape similar to that of the first recess 25 in its planar shape. The second recess 26 surrounds externally the entire periphery of the first recess 25. The first recess 25 and the second recess 26 are arranged concentrically.

Accordingly, a distance between an outer circumferential end of the first recess 25 and an inner circumferential end of the second recess 26 is constant over the entire periphery, and the distance is, for example, around 20 μm. The first recess 25 has a diameter of around 35 μm, for example. The second recess 26 has a width of around 20 μm, for example (which is equal to the distance between the first recess 25 and the second recess 26 described above), an internal diameter of around 75 μm, for example, and an external diameter of around 115 μm, for example. Moreover, a gap between adjacent recess portions 24 in the X-axis direction is around 20 μm, for example (which is equal to the distance between the first recess 25 and the second recess 26 and equal to the width of the second recess 26 described above). Moreover, a distance from the recess portions 24 disposed at the end of the circuit covering portion 19a1 in the X-axis direction to the end of the circuit covering portion 19a1 is, for example, around 20 μm (which is equal to the distance between the first recess 25 and the second recess 26, equal to the width of the second recess 26, and equal to the gap between adjacent recess portions 24 described above). As illustrated in FIG. 9, the first recess 25 and the second recess 26 are each a through hole in the planate film 19. It should be noted that each of the dimension concerning the recess portion 24 described above is only exemplary description, and its specific numeric value is variable appropriately. In addition, FIG. 8 only illustrates the planate film 19 selectively from the insulating films 16, 19, 21.

Now, as illustrated in FIGS. 5 and 9, the circuit covering portion 19a1 of the main portion 19a in the planate film 19 includes grooves 27 configured to extend along a circumferential direction thereof. The grooves 27 overlap the sealing portion 11p and partially recesses the circuit covering portion 19a1 of the main portion 19a. Plural (two or three) grooves 27 are arranged in parallel and extend along a direction where the plural recess portions 24 are arranged. Similar to the recess portions 24, the grooves 27 are each a through hole in the planate film 19. One of the grooves 27 on an outer end side is disposed adjacent to the plural recess portions 24 arranged in the side portions 11b1, 11b2 toward the active area AA (internally). A distance between the groove and the recess portions 24 described above is, for example, around 20 μm (which is equal to the distance between the first recess 25 and the second recess 26 and the width of the second recess 26 between the adjacent recess portions 24 described above). The grooves 27 are formed in such a manner as above, whereby a contact area of the sealing portion 11p to the array substrate 11b (specifically, to the interlayer insulating film 21) is increased and an extension distance of an interface between the array substrate 11b and the sealing portion 11p becomes longer. This leads to difficulty in reaching of moisture external of the liquid crystal panel 11 into the liquid crystal layer 11c through the interface between the array substrate 11b and the sealing portion 11p. Consequently, poor display caused by entering of water into the liquid crystal layer 11c is suppressible or preventable.

In order to form the alignment film 11o in the array substrate 11b, the material of the alignment film 11o with low viscosity and high flowability is supplied to the active area AA of the glass substrate 11GS. The material flows over the innermost face of the array substrate 11b (on an upper layer side with respect to the interlayer insulating film 21 in the glass substrate 11GS), whereby the alignment film 11o is formed on the active area AA at least almost entirely. Specifically, the material of the alignment film 11o is applied to the array substrate 11b with use of an inkjet device. When the application is performed, nozzles of the inkjet device discharges droplets as the material of the alignment film 11o intermittently within the active area AA and impacts the droplets onto the second transparent electrode film 22. The droplets of the material of the alignment film 11o impacted onto the second transparent electrode film 22 in the active area AA flow in such a manner as to leak over from a point where the droplets impact on the surfaces of the interlayer insulating film 21 and the second transparent electrode film 22, and the droplets spread at least partially from the active area AA to the non-active area NAA. As illustrated in FIG. 5, when reaching a position in the non-active area NAA where the sealing portion 11p is to be formed, the material of the alignment film 11o spreads externally beyond the plural grooves 27 in the main portion 19a (circuit covering portion 19a1) of the planate film 19 to the second recess 26 that is disposed in the main portion 19a (circuit covering portion 19a1) of the planate film 19 and that forms the recess portion 24. Here, the first recess 25 is surrounded by the second recess 26 in the endless annular shape over its entire periphery. Consequently, the alignment film 11o is unlikely to flow toward the first recess 25 beyond the second recess 26, and thus the material of the alignment film 11o is unlikely to enter into the first recess 25. Such a situation easily occurs. Especially, the second recess 26 has the endless annular shape. Accordingly, flow of the material of the alignment film 11o toward the first recess 25 is regulatable with higher accuracy than a case where the second recess has an ended annular shape. Consequently, the material of the alignment film 11o is more unlikely to enter into the first recess 25. As described above, when the alignment film 11o is prevented from being formed within the first recess 25, such a situation is unlikely to occur where the region of the sealing portion 11p that covers at least the first recess 25 overlaps the alignment film 11o. Therefore, the adhesive strength of the sealing portion 11p with respect to the array substrate 11b can be kept sufficiently high even if a narrower frame is developed, leading to difficulty in removal of the sealing portion 11p from the array substrate 11b. Moreover, the material of the alignment film 11o flowing over the non-active area NAA is a liquid with low viscosity. This leads to difficulty in accurate control of a range of the material spreading over the array substrate 11b. Accordingly, large individual difference may be generated in the area where the film is formed in the non-active area NAA. Regarding this embodiment, the plural recess portions 24 are spaced apart in the circumferential direction of the array substrate 11b. In addition, the second recesses 26 each have an endless annular ring contour. Accordingly, with assistance of the gap between the adjacent recess portions 24 and the contour of the second recesses 26, it is possible to let the material of the flowing alignment film 11o in the non-active area NAA escape to a direction away from the active area AA. This makes it easy to obtain the even film thickness of the alignment film 11o in the non-active area NAA.

Moreover, as illustrated in FIG. 9, the recess portions 24 described above are provided not in the interlayer insulating film 21 but in the planate film 19 exclusively. Accordingly, the (flat) circuit covering portion 21a1 of the interlayer insulating film 21 with no opening by the recess portions 24 is overlaid on an upper layer side of the circuit covering portion 19a1 of the planate film 19 that is opened partially by the recess portions 24. As described above, the circuit covering portion 21a1 of the interlayer insulating film 21 ensures coverage (step coverage) of the circuit portion 23, leading to difficulty in building up corrosion in the circuit portion 23. In addition, the recess portions 24 are selectively disposed not in the interlayer insulating film 21 whose film thickness is relatively small but in the planate film 19 whose film thickness is relatively large. This ensures a sufficient depth of the recess portion 24. Consequently, it becomes difficult for the material of the alignment film 11o to reach the first recess 25 beyond the second recess 26. Moreover, similar to the recess portions 24, the grooves 27 are selectively provided in the planate film 19, and thus the interlayer insulating film 21 is overlaid on the upper layer side of the planate film 19.

Moreover, as illustrated in FIGS. 5, 8, and 10, at least the tubular portions 28 formed by the planate film 19 are disposed in the circuit non-arrangement area CNA at the corner portion 11b3 of the array substrate 11b. The tubular portions 28 are each cylindrical, and include an opening 28a at the center thereof whose planar shape is circular. The tubular portions 28 have a laminated structure formed by the interlayer insulating film 21 in addition to the planate film 19. The tubular portions 28 are spaced apart between the main portions 19a, 21a of the planate film 19 and the interlayer insulating film 21, respectively. With such a configuration, even if the material of the alignment film 11o reaches the tubular portions 28 over the main portions 19a, 21a of the planate film 19 and the interlayer insulating film 21 during formation of the alignment film 11o, the material is unlikely to enter into the openings 28a beyond the tubular portions 28. Such a situation occurs. Therefore, the adhesive strength of the sealing portion 11p with respect to the array substrate 11b can be kept sufficiently high, leading to difficulty in removal of the sealing portion 11p.

Here, as illustrated in FIG. 5, the sealing portion 11p is disposed in such a manner that the outer edge thereof is withdrawn inwardly from the outer edge of the array substrate 11b. Consequently, in order to produce the liquid crystal panel 11, a CF substrate preform made by coupling many CF substrates 11a successively adheres to an array substrate preform made by coupling many array substrates 11b successively to produce a preform panel made by coupling many liquid crystal panel 11, and then the preform panel is divided (split, scribed) to obtain individual liquid crystal panels 11. When such a technique is adopted, the sealing portion 11p is disposed out of a point of the liquid crystal panel 11 where the preform panel is divided. This achieves easy division of the preform panel. Moreover, in this embodiment, as described above, when the outer edge of the sealing portion 11p is withdrawn inwardly from the outer edge of the array substrate 11b, the gap between the outer edge of the sealing portion 11p and the main portion 19a of the planate film 19 withdrawn inwardly from the outer edge of the sealing portion 11p is smaller than the outer diameter of the second recess 26. This makes it difficult to set a structure, such as the recess portions 24, for regulating flow of the alignment film 11o between the main portion 19a and the outer edge of the sealing portion 11p. Regarding this, providing the recess portions 24 in the main portion 19a of the planate film 19 allows suitable flow of the alignment film 11o in the main portion 19a, which makes it difficult to cause removal of the sealing portion 11p.

As described above, the liquid crystal panel (display panel) 11 according to this embodiment includes the paired substrates 11a, 11b, the sealing portion 11p, the alignment film 11o, the planate film 19 as an insulating film, and the recess portions 24. The paired substrates 11a, 11b include the plate faces configured to be divided into the active area AA where an image is displayed and the non-active area NAA out of the active area

AA and arranged in such a manner as to face to each other across the interior space 11IS. The sealing portion 11p is interposed between the paired substrates 11a, 11b, and is arranged in the non-active area NAA in such a manner as to surround the interior space 11IS for sealing the interior space 11IS. The alignment film 11o is disposed in at least the active area AA of the array substrate (one substrate) 11b of the paired substrates 11a, 11b. The planate film 19 is arranged in the array substrate 11b farther from the interior space 11IS than alignment film 11o across the active area AA and the non-active area NAA. The recess portions 24 are disposed in the non-active area NAA on the planate film 19 as the insulating film in such a manner as to overlap the sealing portion 11p. The recess portions 24 each include at least the first recess 25 and the second recess 26 configured to extend in such a manner as to surround the first recess 25.

With such a configuration, the interior space 11IS between the paired substrates 11a, 11b is surrounded and thus sealed by the sealing portion 11p disposed between the paired substrates 11a, 11b in the non-active area NAA. When the material of the alignment film 11o supplied to the active area AA spreads to the non-active area NAA while the alignment film 11o to be disposed on at least the active area AA is formed, the alignment film 11o overlays the sealing portion 11p. In such a condition, the adhesive strength of the sealing portion 11p with respect to the array substrate 11b may be reduced. Especially, the adhesive strength of the sealing portion 11p is likely to be lowered significantly as a narrower frame is developed. Here, the recess portions 24 are disposed at the position of the planate film 19 as the insulating film in the array substrate 11b farther from the interior space 11IS than the alignment film 11o, and at the position, the planate film 19 as the insulating film overlays the sealing portion 11p in the non-active area NAA. The recess portions 24 each include at least the first recess 25 and the second recess 26 configured to extend in such a manner as to surround the first recess 25. Consequently, the material of the alignment film 11o having spread up to the non-active area NAA is unlikely to flow toward the first recess 25 beyond the second recess 26, and thus the material of the alignment film 11o is unlikely to enter into the first recess 25. Such a situation occurs. This causes difficulty in overlapping the alignment film 11o with at least a region of the sealing portion 11p where the first recess 25 is covered. Therefore, the adhesive strength of the sealing portion 11p with respect to the array substrate 11b can be kept sufficiently high even if a narrower frame is developed, leading to difficulty in removal of the sealing portion 11p.

Moreover, the array substrate 11b includes the metal films 15, 18 and the circuit portion 23. The metal films 15, 18 are disposed farther from the interior space 11IS than the planate film 19 as the insulating film. The circuit portion 23 is disposed at least in the non-active area NAA, and is formed by the metal films 15, 18. The planate film 19 as the insulating film includes the circuit covering portion 19a1 configured to cover the circuit portion 23. The circuit covering portion 19a1 is partially recessed to form the recess portions 24. With such a configuration, the planate film 19 as the insulating film includes the circuit covering portion 19a1 configured to cover the circuit portion 23 formed by the metal films 15, 18. This causes difficulty in building up corrosion in the circuit portion 23. The recess portions 24 are formed by recessing the circuit covering portions 19a1 partially. This causes difficulty in loss of an anticorrosive function of the circuit portions 23 by the planate film 19 as the insulating film.

Moreover, the array substrate 11b has a rectangular planar shape, and includes the outer circumference portion with the corner portion 11b3 and the side portions 11b1, 11b2. The corner portion 11b3 includes the circuit non-arrangement area CNA where the circuit portion 23 is not arranged. The side portions 11b1, 11b2 each include the circuit arrangement area CA where the circuit portion 23 is arranged. The planate film 19 as the insulating film includes the main portion 19a that is withdrawn inwardly from the outer edge of the array substrate 11b, and configured not to be arranged in at least the circuit non-arrangement area CNA and to contain the circuit covering portion 19a1. In the circuit non-arrangement area CNA, the tubular portions 28 are provided in such a manner as to be spaced apart from the main portion 19a. The tubular portions 28 are formed by the planate film 19 as the insulating film and each include the opening 28a at the center. In doing so, the corner portion 11b3 of the outer circumference in the array substrate 11b includes the circuit non-arrangement area CNA where the circuit portion 23 is not arranged. Accordingly, if the main portion 19a of the planate film 19 as the insulating film is not arranged in the circuit non-arrangement area CNA, this is unlikely to influence corrosion of the circuit portion 23. The main portion 19a of the planate film 19 as the insulating film is not arranged in the circuit non-arrangement area CNA, leading to the enhanced adhesive strength of the sealing portion 11p at the corner portion 11b3. In addition, the tubular portions 28 formed by the planate film 19 as the insulating film and each including the openings 28a at the center thereof are disposed in the circuit non-arrangement area CNA configured to be spaced apart from the main portion 19a of the planate film 19 as the insulating film. Consequently, even if the material of the alignment film 11o reaches the tubular portions 28 over the main portion 19a of the planate film 19 as the insulating film while the alignment film 11o is formed, the material is unlikely to enter into the openings 28a beyond the tubular portions 28. Such a situation occurs. Therefore, the adhesive strength of the sealing portion 11p with respect to the array substrate 11b can be kept sufficiently high, leading to difficulty in removal of the sealing portion 11p.

Moreover, the insulating film includes at least the planate film (recess arrangement insulating film) 19 including the recess portions 24 selectively and the interlayer insulating film (recess non-arrangement insulating film) 21. With such a configuration, the circuit covering portion 21a1 of the interlayer insulating film 21 without any recess portion 24 is covered with the circuit covering portion 19a1 of the planate film 19 with the recess portions 24. This causes more difficulty in building up corrosion in the circuit portion 23.

Moreover, the planate film 19 has a film thickness larger than that of the interlayer insulating film 21. With such a configuration, the film thickness of the planate film 19 including the recess portions 24 selectively is relatively large. This ensures a sufficient depth of the recess portions 24. Consequently, the recess portions 24 enable suitable regulation of flow of the alignment film 11o.

Moreover, the insulating film includes at least the planate film (first insulating film) 19 whose film thickness is relatively large, and the interlayer insulating film (second insulating film) 21 whose film thickness is relatively small. The recess portions 24 each include at least the second recess 26 selectively in the planate film 19. In doing so, the second recess 26 is deeper than a case where a second recess is selectively disposed in the interlayer insulating film 21. Consequently, the second recess 26 enables suitable regulation of flow of the alignment film 11o. This makes it more difficult to cause the material of the alignment film 11o to reach the first recess 25.

Moreover, the sealing portion 11p is provided in such a manner that its outer edge is withdrawn inwardly from the outer edge of the array substrate 11b. The planate film 19 as the insulating film includes the main portion 19a withdrawn inwardly from the outer edge of the sealing portion 11p by a gap smaller than the external diameter of the second recess 26 forming the recess portion 24. The recess portion 24 is provided in the main portion 19a. Firstly, the outer edge of the sealing portion 11p is provided so as to be withdrawn inwardly from the outer edge of the array substrate 11b. Accordingly, when the liquid crystal panel 11 of this type is produced by dividing a preform panel composed by coupling the liquid crystal panels 11, for example, the sealing portion 11p is disposed out of the point where the preform panel is divided. This achieves easy division of the preform panel. Moreover, when the outer edge of the sealing portion 11p is provided so as to be withdrawn inwardly from the outer edge of the array substrate 11b, a gap between the outer edge of the sealing portion 11p and the main portion 19a of the planate film 19 as the insulating film withdrawn inwardly from the outer edge of the sealing portion 11p is occasionally smaller than the external diameter of the second recess 26. In such a condition, it becomes difficult to set a structure, such as the recess portion 24, for regulating flow of the alignment film 11o between the main portion 19a and the outer edge of the sealing portion 11p. Regarding this, providing the recess portion 24 in the main portion 19a allows suitable flow of the alignment film 11o in the main portion 19a, which makes it difficult to cause removal of the sealing portion 11p.

Moreover, the second recess 26 of the recess portion 24 has an endless annular shape. In doing so, flow of the material of the alignment film 11o toward the first recess 25 is regulatable with higher accuracy than a case where the second recess has an ended annular shape. Consequently, the material of the alignment film 11o is more unlikely to enter into the first recess 25.

Moreover, recess portions 24 are spaced apart along the circumferential direction of the array substrate 11b, and at least second recesses 26 each have an annular ring contour. Even if the second recesses each forming the recess portions extend along the circumferential direction of the array substrate 11b, the second recesses cause the material of the alignment film 11o flowing during formation of the alignment film 11o to return toward the active area AA, resulting in possibility that the alignment film 11o has an uneven film thickness. In contrast to this, the recess portions 24 arranged along the circumferential direction of the array substrate 11b are spaced apart by gaps, and additionally, the second recesses 26 each have the annular ring contour. With assistance of the gaps and the contour of the second recesses 26, it is possible to let the material of the flowing alignment film 11o escape to a direction away from the active area AA in the non-active area NAA. This makes it easy to obtain the even film thickness of the alignment film 11o in the non-active area NAA.

### Second Embodiment

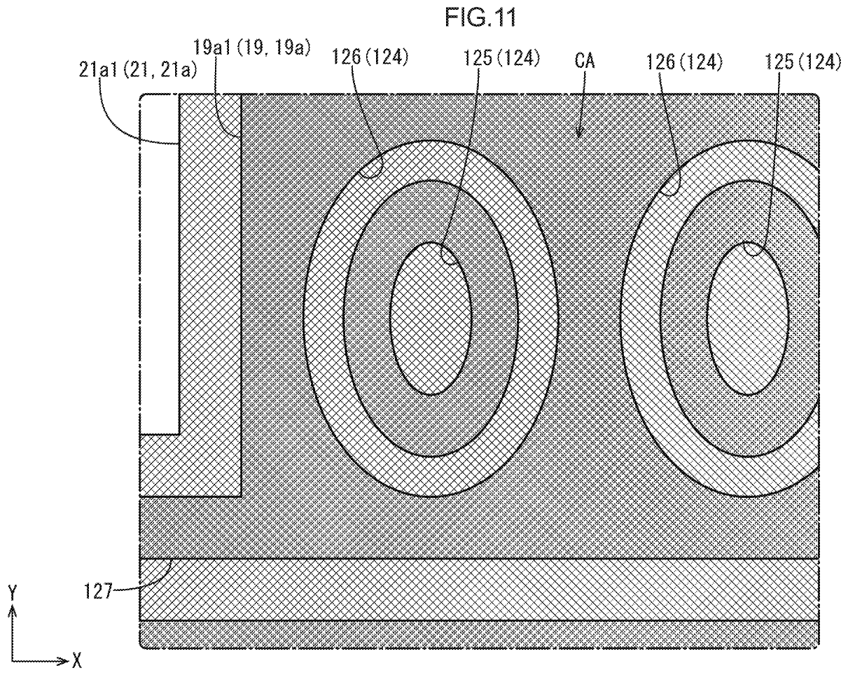

The following describes a second embodiment of the present invention with FIG. 11. In the second embodiment, a recess portion 124 has a varied planar shape. Here, the description of the configuration and operational advantage common to that of the first embodiment described above is to be omitted.

As illustrated in FIG. 11, the recess portion 124 according to this embodiment has a substantially oval planar shape. Specifically, a first recess 125 forming the recess portion 124 has an oval planar shape in which a long axis direction thereof corresponds to the Y-axis direction and a short axis direction thereof corresponds to the X-axis direction. A second recess 126 forming the recess portion 124 has an endless oval annular planar shape in which a long axis direction and a short axis direction thereof are equal to those of the first recess 125. The long axis direction of the recess portion 124 is perpendicular to a direction where a groove portion 127 extends (X-axis direction).

### Third Embodiment

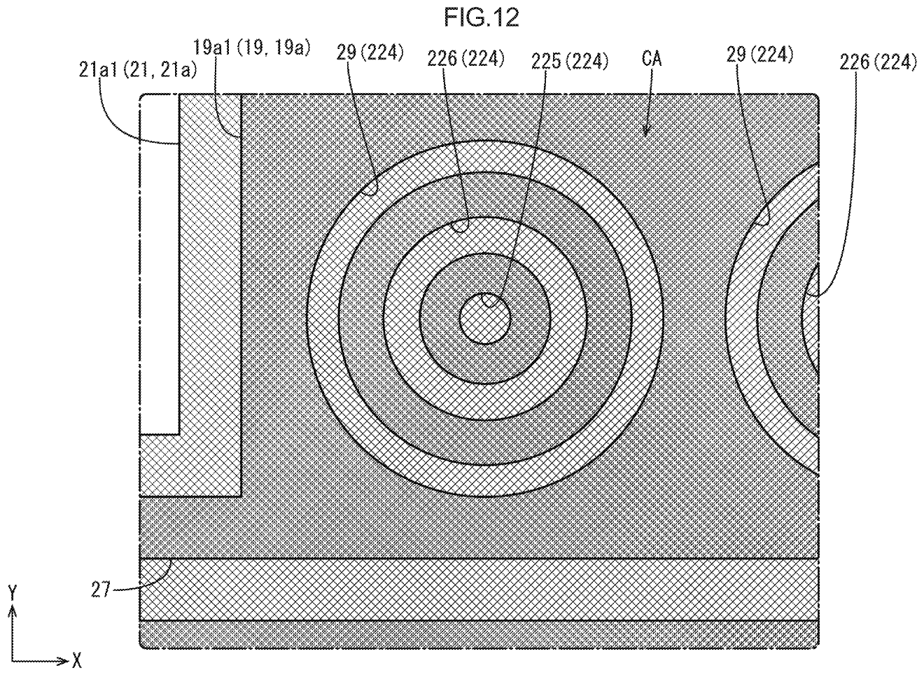

The following describes a third embodiment of the present invention with FIG. 12. The third embodiment illustrates a variation in configuration of a recess portion 224 based on the first embodiment described above. Here, the description of the configuration and operational advantage common to that of the first embodiment described above is to be omitted.

As illustrated in FIG. 12, the recess portion 224 according to this embodiment includes a third recess 29 configured to extend in such a manner as to surround a second recess 226. The third recess 29 is disposed outwardly from the second recess 226 (opposite side to a first recess 225). The third recess 29 has an endless annular ring shape larger by one order than the second recess 226, and its shape is similar to that of the second recess 226. A distance between an inner circumferential end of the third recess 29 and an outer circumferential end of the second recess 226 is substantially equal to a distance between an outer circumferential end of the first recess 225 and an inner circumferential end of the second recess 226. With such a configuration, the material of the alignment film (not shown) is necessarily beyond the third recess 29 and further beyond the second recess 226 for reaching the first recess 225 when the film is formed. This makes it more difficult for a region of the sealing portion (not shown) that covers at least the first recess 225 to overlap the alignment film. Then, the adhesive strength of the sealing portion to the array substrate can keep higher with high reliability.

According to this embodiment described above, the recess portion 224 includes the third recess 29 extending in such a manner as to surround the second recess 226. With such a configuration, the second recess 226 extending in such a manner as to surround the first recess 225 is also surrounded by the third recess 29. Accordingly, the material of the alignment film is necessarily beyond the third recess 29 and the second recess 226 for reaching the first recess 225 when the film is formed. This makes it more difficult for a region of the sealing portion that covers at least the first recess 225 to overlap the alignment film. Then, the adhesive strength of the sealing portion to the array substrate can keep higher with high reliability.

### Fourth Embodiment

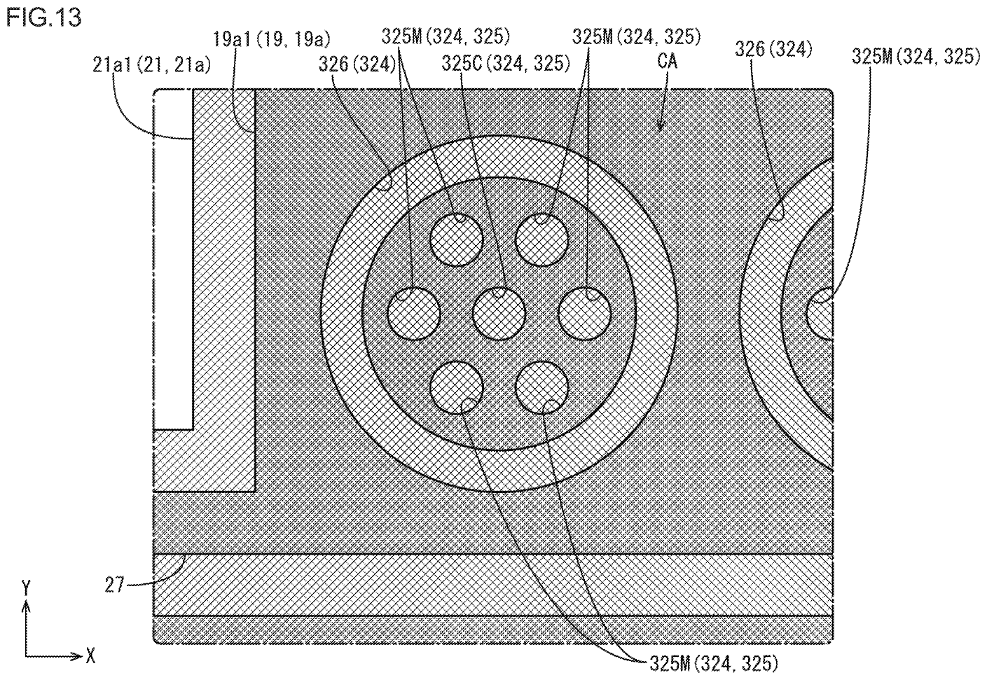

The following describes a fourth embodiment of the present invention with FIG. 13. The fourth embodiment illustrates a variation in configuration of a recess portion 324 based on the first embodiment described above. Here, the description of the configuration and operational advantage common to that of the first embodiment described above is to be omitted.

As illustrated in FIG. 13, the recess portion 324 according to this embodiment includes first recesses 325. Specifically, seven first recesses 325 in total are spaced apart by substantially equal gaps in a region surrounded by a second recess 326. The seven first recesses 325 include a central first recess 325C disposed at the center of the recess portion 324 concentrically with the second recess 326 and six intermediate recesses 325M disposed between the central first recess 325C and the second recess 326. With such a configuration, the seven first recesses 325 are arranged in line even when the material of the alignment film (not shown) is beyond the second recess 326 and reaches to the region surrounded by the second recess 326. Accordingly, a probability that the first recesses 325 without the material of the alignment film remain becomes higher than a case where only one first recess 25 is provided as described in the first embodiment (see FIG. 7). This makes it more difficult for a region of the sealing portion (not shown) that covers at least the first recess 325 to overlap the alignment film. Then, the adhesive strength of the sealing portion to the array substrate can keep higher with high reliability.

According to this embodiment described above, the recess portion 324 includes the plural first recesses 325 that are spaced apart by gaps in the region surrounded by the second recess 326. With such a configuration, even when the material of the alignment film is beyond the second recess 326 and reaches the region surrounded by the second recess 326, the first recesses 325 are arranged in line the region. Accordingly, a probability that the first recesses 325 without the material of the alignment film remain becomes higher than a case where only one first recess is provided. This makes it more difficult for a region of the sealing portion that covers at least the first recess 325 to overlap the alignment film. Then, the adhesive strength of the sealing portion to the array substrate can keep higher with high reliability.

### Fifth Embodiment

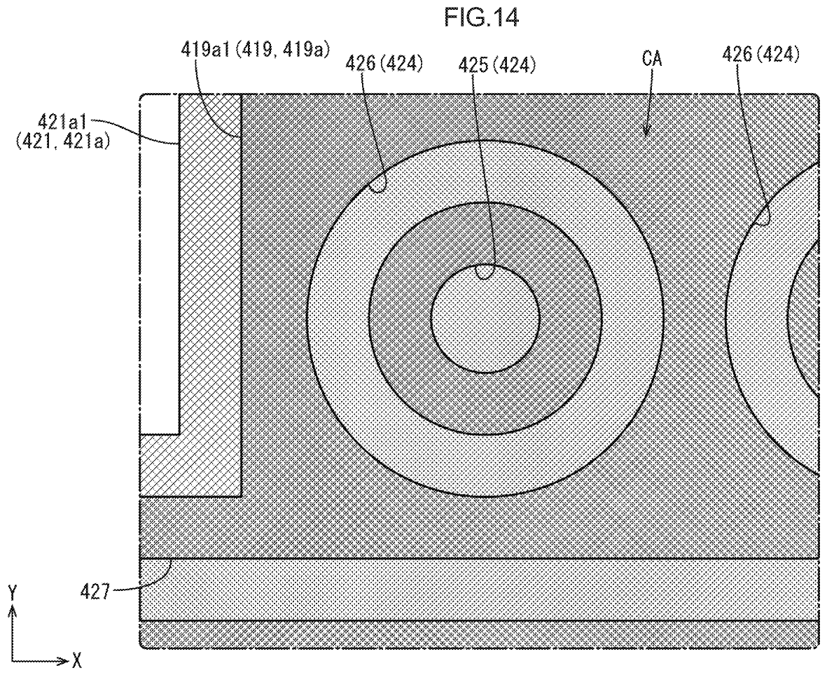

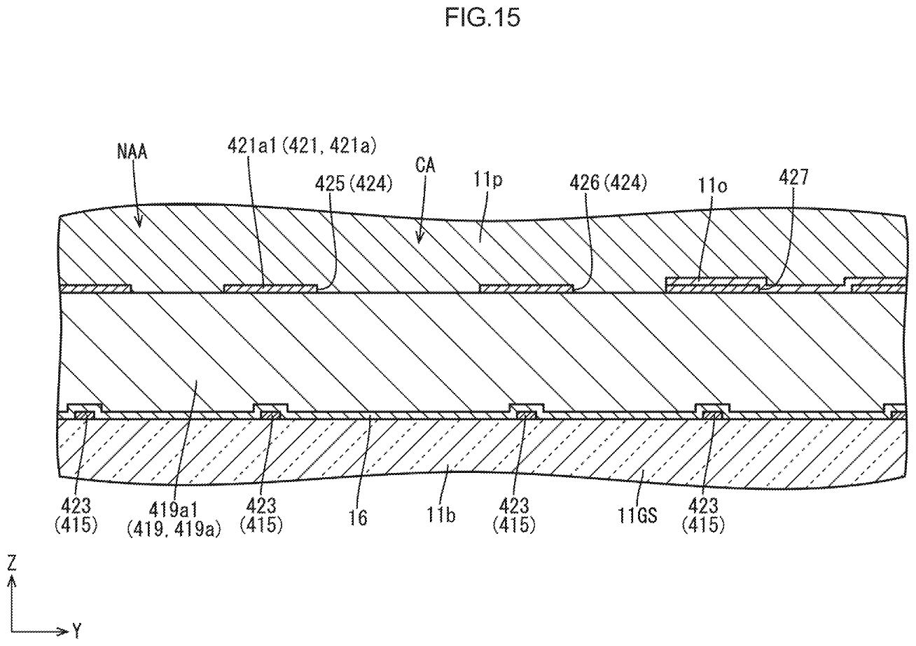

The following describes a fifth embodiment of the present invention with FIG. 14 or 15. The fifth embodiment illustrates a variation in setting target of a recess portion 424 based on the first embodiment described above. Here, the description of the configuration and operational advantage common to that of the first embodiment described above is to be omitted.

As illustrated in FIGS. 14 and 15, the recess portion 424 according to this embodiment includes an interlayer insulating film 421 selectively. Specifically, a first recess 425 and a second recess 426 that form the recess portion 424 are provided in such a manner as to partially recess a circuit covering portion 421a1 on a main portion 421a of the interlayer insulating film 421. More specifically, the first recess 425 and the second recess 426 are each a through hole in a circuit covering portion 421a1. However, the recess portion 424 is not arranged on a planate film 419 whose film thickness is larger than the interlayer insulating film 421. Accordingly, a circuit covering portion 419a1 of a main portion 419a in the planate film 419 achieves more satisfied coverage of a circuit portion 423. This makes it more difficult to corrode a part of a metal film forming the circuit portion 423 (containing a first metal film 415). Now, similar to the recess portion 424, a groove 427 is selectively provided in the interlayer insulating film 421.

According to this embodiment described above, the planate film (recess non-arrangement insulating film) 419 has a film thickness larger than that of the interlayer insulating film (recess arrangement insulating film) 421. In doing so, the film thickness of the planate film 419 where no recess portion 424 is arranged is relatively large. This makes it more difficult to cause the circuit covering portion 419a1 of the planate film 419 to corrode the circuit portion 423.

### Sixth Embodiment

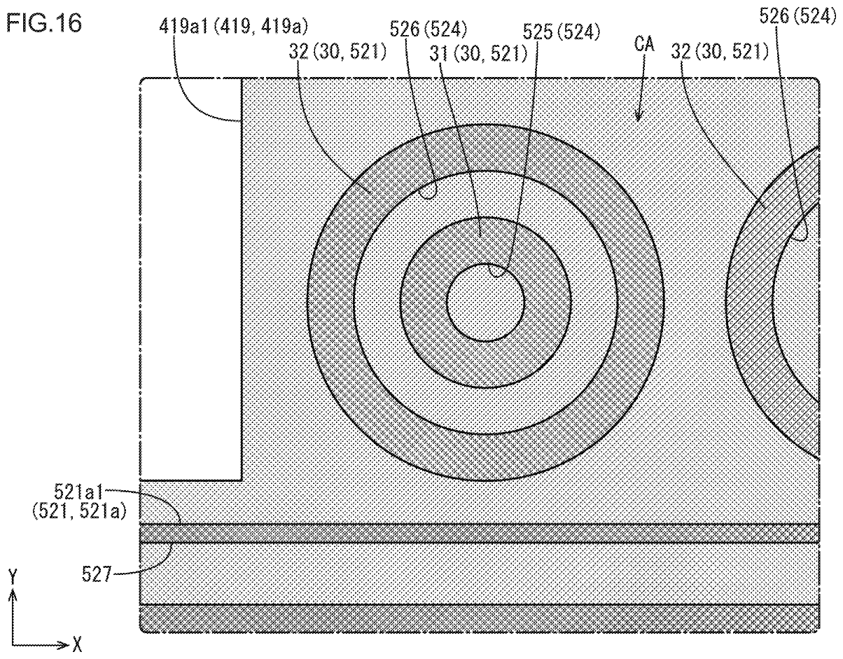

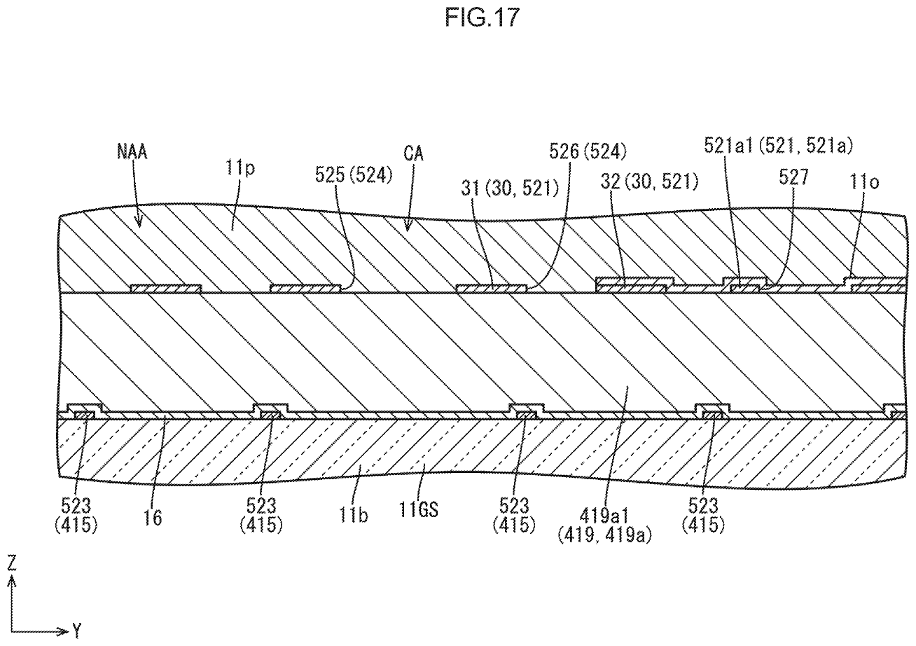

The following describes a sixth embodiment of the present invention with FIG. 16 or 17. The sixth embodiment illustrates a variation in area where an interlayer insulating film 521 is formed based on the fifth embodiment described above. Here, the description of the configuration and operational advantage common to that of the fifth embodiment described above is to be omitted.

As illustrated in FIGS. 16 and 17, an interlayer insulating film 521 according to this embodiment includes an area where an outer edge of a main portion 521a (circuit covering portion 521a1) is formed slightly outwardly from a groove 527. A recess constituent portion 30 formed by the interlayer insulating film 521 is provided at a position outwardly apart from the main portion 521a of the interlayer insulating film 521 (opposite to the groove 527 (active area)). The recess constituent portion 30 is formed like an island separated from the main portion 521a. The recess constituent portion 30 is formed by a first recess constituent portion 31 configured to surround a first recess 525 and a second recess constituent portion 32 configured to surround a second recess 526. The first recess constituent portion 31 has an endless annular ring shape whose inner circumferential end conforms to an outer circumferential end of the first recess 525. The second recess constituent portion 32 has an endless annular ring shape whose inner circumferential end conforms to an outer circumferential end of the second recess 526. The first recess 525 is formed by the first recess constituent portion 31 configured to surround the first recess 525 itself, whereas the second recess 526 is formed by the first recess constituent portion recess constituent portion 31 and the second recess constituent portion 32 configured to sandwich the second recess 526 inwardly and outwardly. Here, the recess constituent portion 30 overlaps circuit portions 523. In other words, the recess constituent portion 30 is a part of the circuit covering portions 521a1. Such a configuration also achieves the same operational advantage as that of the fifth embodiment described above.

### Seventh Embodiment

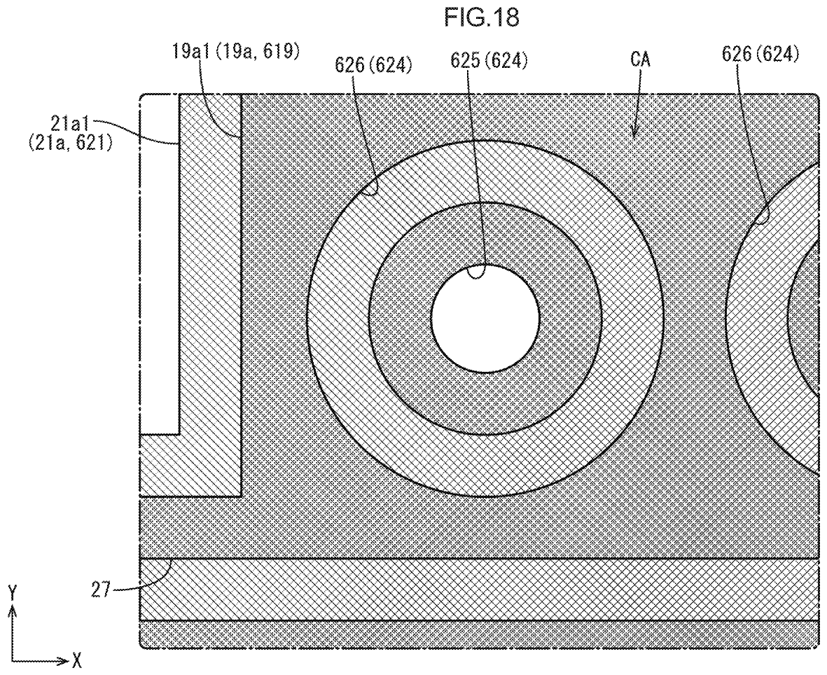

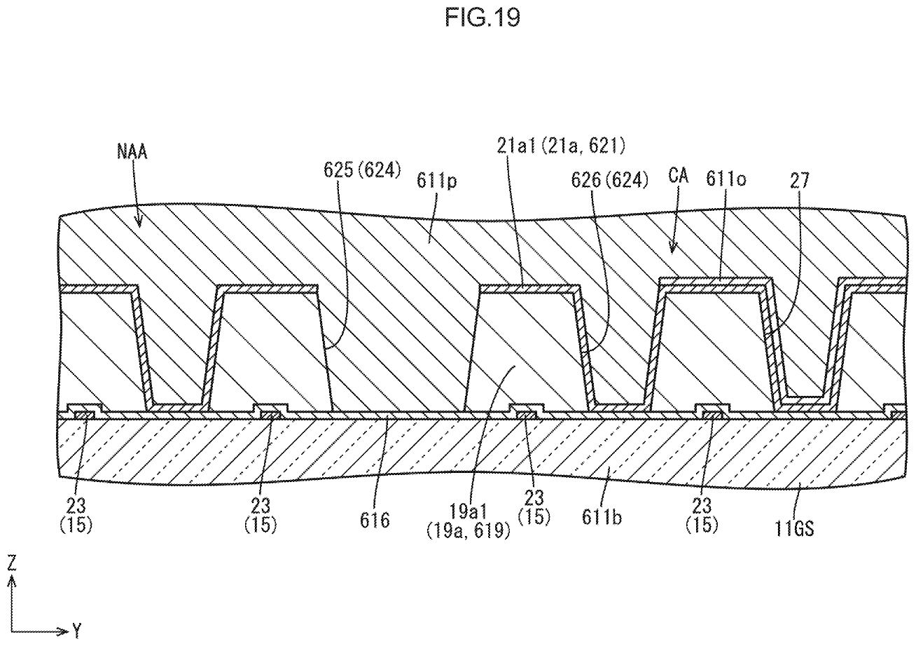

The following describes a seventh embodiment of the present invention with FIG. 18 or 19. The seventh embodiment illustrates a variation in configuration of a recess portion 624 based on the first embodiment described above. Here, the description of the configuration and operational advantage common to that of the first embodiment described above is to be omitted.

As illustrated in FIGS. 18 and 19, a first recess 625 of the recess portion 624 according to this embodiment is a through hole in a planate film 619 and also in an interlayer insulating film 621. With such a configuration, a sealing portion 611p enables to contact an array substrate 611b directly through the planate film 619 and the interlayer insulating film 621 via the first recess 625 where no alignment film 611o is arranged (in this embodiment, contact via a gate insulating film 616). A second recess 626 regulates flow of the material of the alignment film 611o, whereby the first recess 625 positively functions to ensure the adhesive strength of the sealing portion 611p. Accordingly, the adhesive strength of the sealing portion 611p to the array substrate 611b becomes higher.

According to this embodiment described above, the recess portion 624 includes the first recess 625 as a thorough hole in the planate film 619 and the interlayer insulating film 621. With such a configuration, the sealing portion 611p can directly contact the array substrate 611b via the first recess 625 as a through hole in the planate film 619 and the interlayer insulating film 621. The second recess 626 regulates flow of the material of the alignment film 611o, whereby the first recess 625 positively functions to ensure the adhesive strength of the sealing portion 611p. Accordingly, the adhesive strength of the sealing portion 611p to the array substrate 611b becomes higher.

### Other Embodiments

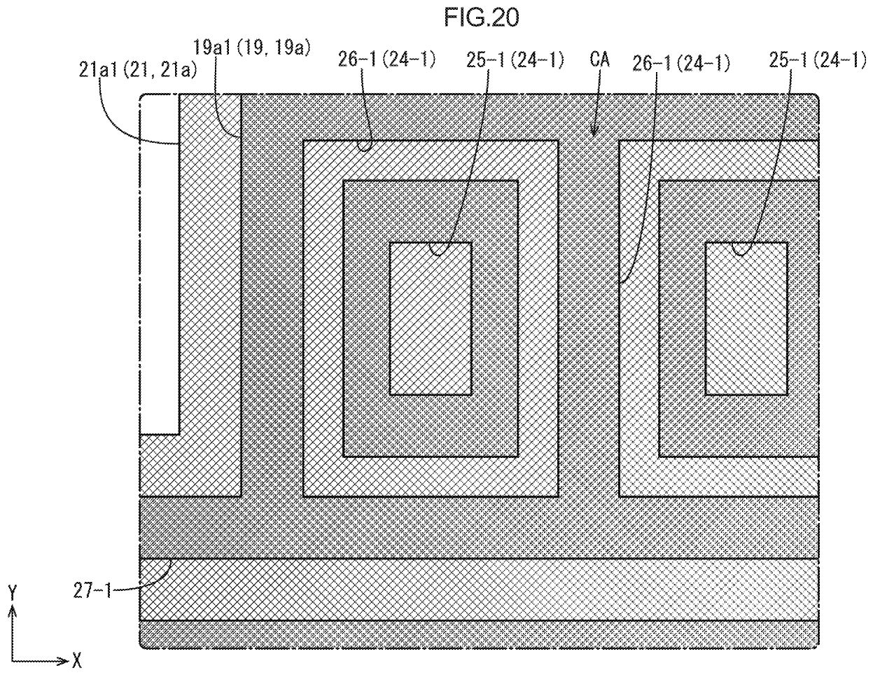

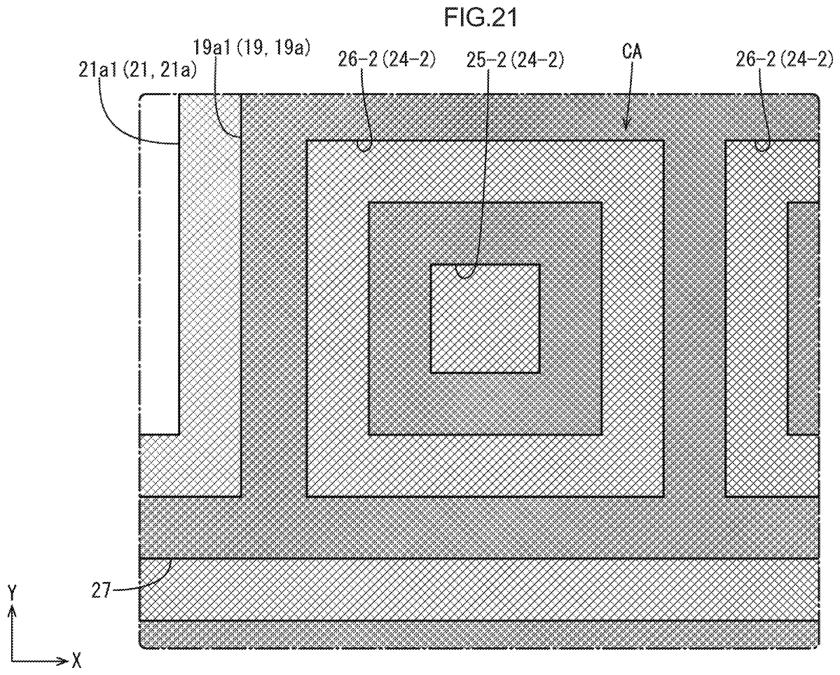

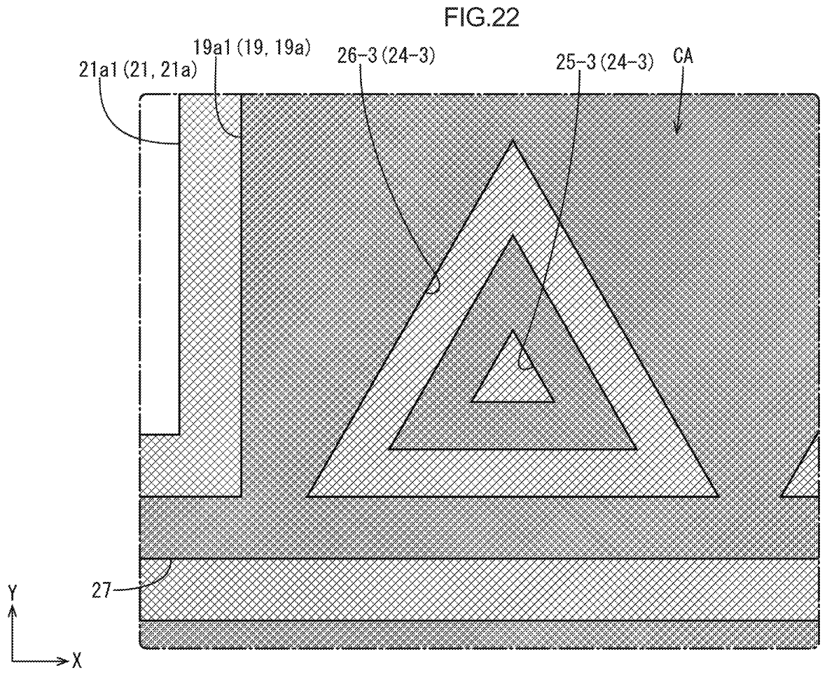

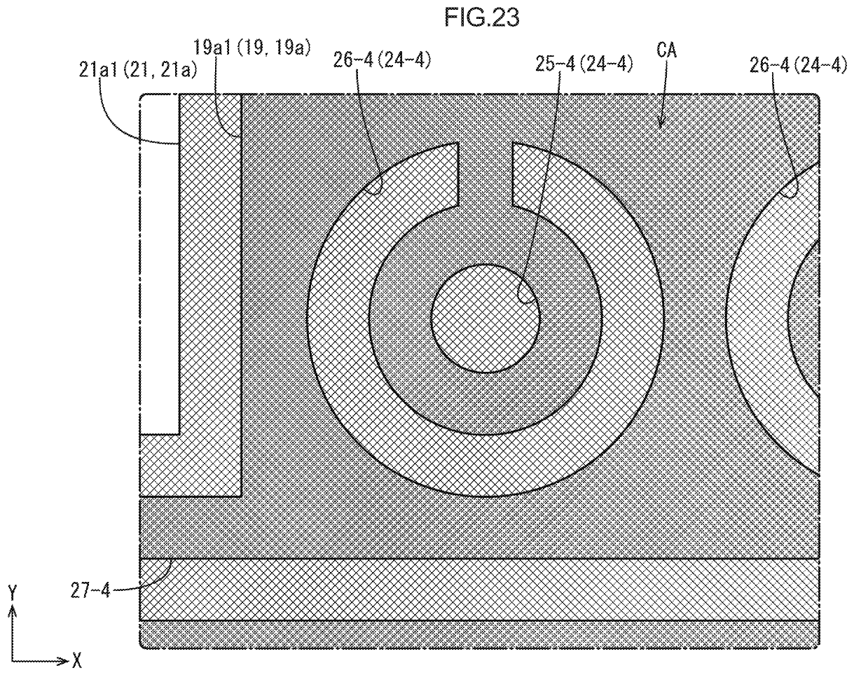

The present invention is not limited to the embodiments described above with the description and the drawings. Such embodiments as below are contained in the technical scope of the present invention.
(1) As for a first modification of the first embodiment described above, a recess portion 24-1 may be oblong (rectangular) in its planar shape as illustrated in FIG. 20. A first recess 25-1 that forms the recess portion 24-1 is oblong, whereas a second recess 26-1 has an oblong and endless rectangle annular shape (box shape, frame shape) in such a manner as to surround the first recess 25-1. The second recess 26-1 has a long side whose direction is perpendicular to a direction where a groove 27-1 extends.
(2) As for a second modification of the first embodiment described above, a recess portion 24-2 may be square in its planar shape as illustrated in FIG. 21. A first recess 25-2 that forms the recess portion 24-2 is square, whereas a second recess 26-2 has an endless square annular shape (box shape, frame shape) in such a manner as to surround the first recess 25-2.
(3) As for a third modification of the first embodiment described above, a recess portion 24-3 may be equilateral triangular in its planar shape as illustrated in FIG. 22. A first recess 25-3 that forms the recess portion 24-3 is equilateral triangular, whereas a second recess 26-3 has an endless equilateral triangular annular shape (box shape, frame shape) in such a manner as to surround the first recess 25-3.
(4) As for a fourth modification of the first embodiment described above, a recess portion 24-4 may be square in its planar shape as illustrated in FIG. 23. A first recess 25-4 that forms the recess portion 24-4 is circular, whereas a second recess 26-4 has an ended annular ring shape in such a manner as to surround the first recess 25-4. Both ends of the second recess 26-4 in a circumferential direction are disposed opposite to a groove 27-4 (adjacent to the active area).
(5) In each of the embodiments described above, the array substrate includes the planate film made from an organic material and having a film thickness larger than the interlayer insulating film. Alternatively, an array substrate without the planate film as above is applicable. In such a case, an interlayer insulating film made from an inorganic material is provided instead of the planate film, and the interlayer insulating film includes a lower interlayer insulating film and an upper interlayer insulating film. Such configuration is applicable. In this case, it is possible to provide a first recess and a second recess, forming a recess portion, on one or both of the lower interlayer insulating film and the upper interlayer insulating film.
(6) Except for the embodiments described above, specific planar shapes of the first recess and the second recess forming the recess portion are variable appropriately. For instance, a horizontally oriented oval shape, a horizontally oriented rectangular shape, a rhomboidal shape, a trapezoid shape, an isosceles triangular shape, and a scalene triangular shape are adoptable. This is similarly applicable to the planar shape of the tubular portion and the opening thereof.
(7) Each of the embodiments described above exemplarily describes the case where the second recess has the inner circumference whose shape conforms to the contour of the first recess. Alternatively, the second recess may have the inner circumference whose shape does not conform to the contour of the first recess. For instance, the contour of the first recess may be polygonal, whereas the second recess may have an inner circumference whose shape is curve, such as a circular or an oval shape. Conversely, the contour of the first recess may be curved, such as circular or oval, whereas the second recess may have an inner circumference whose shape is polygon. Adaptation of such a configuration achieves variation in distance between the outer circumferential end of the first recess and the inner circumferential end of the second recess depending on circumferential direction positions thereof.
(8) Combination of the third and fourth embodiments described above is performable for arranging first recesses intermittently in a region in the recess portion with the third recess, the region being surrounded by the second recess.
(9) The configurations described in the fifth and sixth embodiments that the recess portions are selectively disposed in the interlayer insulating film are applicable to the configurations described in the second to fourth embodiments or other embodiments described in the above (1) to (4).
(10) The configuration described in the seventh embodiment that the first recess is the through hole in both the planate film and the interlayer insulating film is applicable to the configurations described in the fifth and sixth embodiments.
(11) In addition to the above description, it is off course possible to combine the technical matters described in the each of the embodiments appropriately.
(12) In the seventh embodiment described above, only the first recess of the recess portion is a through hole in both the planate film and the interlayer insulating film. Alternatively, the second recess may also be a through hole in both the planate film and the interlayer insulating film.
(13) In the other embodiment (4) described above, the second recess having the ended annular ring shape is exemplarily described. However, in addition to the illustration, another variation is appropriately performable for a specific length by which the second recess extends (a gap between the both ends thereof in the circumferential direction) . It becomes possible to produce a function of regulating flow of the alignment film to the first recess as long as the length by which the second recess forming the ended annular shape (including the ended annular ring shape and the ended polygonal ring shape) extends is at least sufficient to surround a half of the outer circumference face of the first recess, for example. Even in such a case, it is preferred that the second recess is arranged in such a manner as to surround an active area of an outer circumference face of the first recess.
(14) In the embodiments described above, the recess portion is a through hole in the planate film and the interlayer insulating film. Alternatively, the recess portion may not be a through hole in the planate film and the interlayer insulating film.
(15) In the embodiments described above, the groove extends in the circumferential direction of the array substrate. Alternatively, the groove may serpentine with respect to the circumferential direction of the array substrate. Moreover, the groove is omittable.
(16) The above embodiments each exemplarily describe the case where the recess portion is provided in the array substrate of the substrates forming the display panel (liquid crystal panel). Alternatively, the present invention is applicable to the case where the recess is provided in the other substrate (CF substrate) of the substrates forming the display panel, the other being different from the array substrate. Specifically, in this case, the recess portion may be provided with an insulating film, such as an overcoat film or a photo spacer, that is provided in the CF substrate.
(17) In the embodiments described above, the planate film is a single layer film made from an organic material. Alternatively, the planate film may be a laminated film made from an organic material and an inorganic material.
(18) In the embodiments described above, the alignment film is applied by the inkjet device. Otherwise, the alignment film may be applied by a printing device, for example.
(19) In the embodiments described above, the driver is subjected to the COG bonding on the array substrate of the liquid crystal panel. Alternatively, the driver maybe subjected to chip on film (COF) bonding on a flexible board.
(20) In the embodiments described above, the semiconductor film forming the channel of the TFT is made from an oxide semiconductor material. Otherwise, continuous grain (CG) silicon or amorphous silicon as one type of polysilicon (polycrystalline silicon) may be used as the semiconductor film material.
(21) In the embodiments described above, the liquid crystal panel is exemplarily described whose operation mode is displayed as an FFS mode. Alternatively, the present invention is applicable to the liquid crystal panel having other modes such as an in-plane switching (IPS) mode, and a vertical alignment (VA) mode.
(22) In the embodiments described above, the color filters of the liquid crystal panel are formed by a three-colored configuration with colors of red, green, and blue as one example. The present invention is also applicable to a liquid crystal panel having four-colored filters formed by coloring portions with colors of red, green, and blue in addition to a color portion with a color of yellow.
(23) The above embodiments each exemplarily describe a transparent liquid crystal panel. Alternatively, the present invention is applicable to other types of panels such as a reflective liquid crystal panel or a semitransparent liquid crystal panel.
(24) In the embodiments described above, the liquid crystal display device (liquid crystal panel or back light device) has the planar oblong shape. Alternatively, the planar shape of the liquid crystal display device may be a horizontal rectangle, a square, a circle, a semicircle, an ellipse, an oval, and a trapezoid.
(25) In the embodiments described above, the liquid crystal panel is exemplarily described with the configuration that the liquid crystal layer is interposed between the paired substrates. Alternatively, the present invention is applicable to the display panel with the configuration that functional organic molecules other than the liquid crystal material are interposed between the paired substrates.

### EXPLANATION OF SYMBOLS

11: liquid crystal panel (display panel)
11a: CF substrate (substrate)
11b, 611b: array substrate (one substrate)
11b1: long-side portion (side portion)
11b2: short-side part (side portion)
11b3: corner portion
11o, 611o: alignment film
11p, 611p: sealing portion
11IS: interior space
15, 415: first metal film (metal film)
18: second metal film (metal film)
19, 619: planate film (insulating film, first insulating film, recess arrangement insulating film)
19a, 419a: main portion
19a1, 419a1: circuit covering portion
21, 521, 621: interlayer insulating film (insulating film, second insulating film, recess non-arrangement insulating film)
21a, 421a, 521a: main portion
21a1, 421a1, 521a1: circuit covering portion
23, 423, 523: circuit portion
24, 24-1, 24-2, 24-3, 24-4, 124, 224, 324, 424, 524, 624: recess portion
25, 25-1, 25-2, 25-3, 25-4, 125, 225, 325, 425, 525, 625: first recess
26, 26-1, 26-2, 26-3, 26-4, 126, 226, 326, 426, 526, 626: second recess
28: tubular portion
28a: opening
29: third recess
419: planate film (insulating film, recess non-arrangement insulating film)
421: interlayer insulating film (insulating film, recess arrangement insulating film)
AA: active area
CA: circuit arrangement area
CNA: circuit non-arrangement area
NAA: non-active area

1. A display panel, comprising:
paired substrates including plate faces each divided into an active area where an image is displayed and a non-active area out of the active area, and arranged in such a manner as to face each other across an interior space;
a sealing portion interposed between the paired substrates and arranged in the non-active area in such a manner as to surround the interior space for sealing the interior space;
an alignment film disposed on at least the display area on one of the paired substrates;
an insulating film disposed on the one of the paired substrates farther from the interior space than the alignment film and arranged across the active area and the non-active area; and
a recess portion disposed in the non-active area on the insulating film in such a manner as to overlap the sealing portion, and including at least a first recess and a second recess configured to extend in such a manner as to surround the first recess.

2. The display panel according to claim 1, wherein
the one of the paired substrates includes a metal film and a circuit portion, the metal film being disposed farther from the interior space than the insulating film, the circuit portion being disposed at least in the non-active area and being formed by the metal film, and
the insulating film includes a circuit covering portion configured to cover the circuit portion, the circuit covering portion being partially recessed to form the recess portion.

3. The display panel according to claim 2, wherein
the one of the paired substrates has a rectangular planar shape, and includes an outer circumference portion with corner portions and side portions, the corner portions each including a circuit non-arrangement area where the circuit portion is not arranged, the side portions each including a circuit arrangement area where the circuit portion is arranged,
the insulating film includes a main portion that is disposed inwardly from an outer edge of the one of the paired substrates, and is configured not to be arranged in at least the circuit non-arrangement area and to contain the circuit covering portion, and
in the circuit non-arrangement area, tubular portions are provided in such a manner as to be spaced apart from the main portion, the tubular portions being formed by the insulating film and each including an opening at the center.

4. The display panel according to claim 2, wherein the insulating film includes at least a recess arrangement insulating film including the recess portion selectively and a recess non-arrangement insulating film.

5. The display panel according to claim 4, wherein the recess arrangement insulating film has a film thickness larger than that of the recess non-arrangement insulating film.

6. The display panel according to claim 4, wherein the recess non-arrangement insulating film has a film thickness larger than that of the recess arrangement insulating film.

7. The display panel according to claim 1, wherein
the insulating film includes at least a first insulating film whose film thickness is relatively large, and a second insulating film whose film thickness is relatively small, and
the recess portion includes at least the second recess selectively in the first insulating film.

8. The display panel according to claim 7, wherein the first recess of the recess portion is a through hole in the first insulating film and the second insulating film.

9. The display panel according to claim 1, wherein
the sealing portion is provided in such a manner that its outer edge is withdrawn inwardly from an outer edge of the one of the paired substrates,
the insulating film includes a main portion withdrawn inwardly from the outer edge of the sealing portion by a gap smaller than an external diameter of the second recess forming the recess portion, and
the recess portion is provided in the main portion.

10. The display panel according to claim 1, wherein the second recess of the recess portion has an endless annular shape.

11. The display panel according to claim 1, wherein
recess portions are spaced apart by gaps along a circumferential direction of the one of the paired substrates, and
at least the second recesses each have an annular ring contour.

12. The display panel according to claim 1, wherein the recess portion includes a third recess configured to extend in such a manner as to surround the second recess.

13. The display panel according to claim 1, wherein first recesses of the recess portions are spaced apart by gaps in a region surrounded by the second recesses.
